(19) United States
(12) Patent Application Publication
(10) Pub. No.: US 2007/0163353 A1
(43) Pub. Date: Jul. 19, 2007

(54) DETECTION OF BLOOD PRESSURE AND BLOOD PRESSURE WAVEFORM

(75) Inventors: Ryszard M. Lec, Philadelphia, PA (US); Marek Swoboda, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 11/608,121

(22) Filed: Dec. 7, 2006

Related U.S. Application Data
(60) Provisional application No. 60/748,361, filed on Dec. 7, 2005.

(51) Int. Cl. G01L 7/00

(52) U.S. Cl. 73/700

(57) ABSTRACT

The novel embodiments include a method, system and device for measuring a fluid characteristic in a conduit. The novel method includes applying a planar force to the conduit and receiving a pressure from the conduit. The pressure is responsive to the fluid and the conduit, where the pressure is received within a predetermined area. Also, the novel method includes processing the pressure to determine the fluid characteristic. The novel device includes a support structure for supporting the conduit and a sensor head in cooperation with the support structure. The sensor head applies a planar force to the conduit, and has a portion least equal to an outer radius of the conduit. The device also includes a pressure transducer located on the sensor head. The pressure transducer receives a pressure from the conduit that is responsive to the fluid and the conduit.

### CROSS-REFERENCE TO RELATED APPLICATIONS

This application claims priority under 35 U.S.C. § 119 (e) from U.S. provisional application Ser. No. 60/748,361, filed on Dec. 7, 2005, entitled “Method and Apparatus for the Detection of Blood Pressure and Blood Pressure Waveform,” which is herein incorporated by reference in its entirety.

### BACKGROUND

For biosensing, blood pressure assessment is probably the single most important medical measurement. Arterial blood pressure is historically the first estimator of blood perfusion and still is the easiest parameter to measure. Therefore, it is a convenient indicator of a patient's health as well as a crucial vital sign. Due to its diagnostic value it is measured in physician 's offices, operating rooms as well as in intensive care units. Tonometers are devices for measuring pressure.

Although blood pressure measurements are well-developed, the existing technology in the field of arterial blood pressure (ABP) measurements is not sufficient in terms of long-term ABP waveform assessment. Thus, there remains a need for models, designs and a new technique of ABP measurements.

### SUMMARY

The novel embodiments include a method, system and device for measuring a fluid characteristic in a conduit. The novel method includes applying a planar force to the conduit and receiving a pressure from the conduit. The pressure is responsive to the fluid and the conduit, where the pressure is received within a predetermined area. Also, the novel method includes processing the pressure to determine the fluid characteristic. The novel device includes a support structure for supporting the conduit and a sensor head in cooperation with the support structure. The sensor head applies a planar force to the conduit, and has a portion least equal to an outer radius of the conduit. The device also includes a pressure transducer located on the sensor head. The pressure transducer receives a pressure from the conduit that is responsive to the fluid and the conduit.

### BRIEF DESCRIPTION OF THE DRAWINGS

FIG. 1 is a block diagram of an exemplary implantable tonometer;

FIG. 2 is an enlarged isometric view of an exemplary implantable blood pressure sensor;

FIG. 3 depicts an array of the pressure transducers coupled to a vessel and their corresponding pressure versus time plots;

FIG. 4 is a view of the bottom part of a sensor head which comprises a plurality of pressure/force transducers;

FIG. 5 depicts exemplary locations of a distributed sensor configuration that permits the measurement of blood pressure waveforms in various locations in the human body;

FIG. 6 depicts a sensor comprising several heads placed around a common artery;

FIG. 7 illustrates variables and coordinate system for use with the embodiments;

FIG. 8 illustrates the implantable tonometer concept utilizing the intrathoracic artery;

FIG. 9 illustrates different structures of three arterial wall layers;

FIG. 10 provides an arterial wall cross section;

FIG. 11 illustrates a generic relationship between stress and strain in the arterial wall tissue;

FIG. 12 illustrates a cross-section of the implantable tonometer for a generic tonometer structure;

FIG. 13 illustrates a conceptual model of the tonometer's sensing path;

FIG. 14 provides a general layout of a two-dimensional tonometer-arterial wall biomechanical system;

FIGS. 15A and 15B illustrate a conceptual model of arterial tonometry;

FIG. 16 illustrates a stress in flattened artery;

FIG. 17 shows a buckling phenomena occurring in the center of the applanation region;

FIG. 18 illustrates contact pressure on a flat portion of artery;

FIG. 19 illustrates a target design of the sensor head;

FIG. 20 is a representation of a spring dashpot linear system;

FIG. 21 illustrates the equivalent simplified spring-dashpot model;

FIG. 22 is a graphical illustration of a sensor head transfer function showing magnitude and phase;

FIG. 23 illustrates a spring-dashpot model of the arterial wall under applanation and undergoing deformation due to the arterial blood pressure;

FIG. 24 illustrates a 3D plot of force acting on the arterial wall;

FIGS. 25-27 show frequency responses for a first three harmonics;

FIGS. 28-30 illustrate a comparison in time domain between the input signal and the arterial wall response for a first three harmonics;

FIGS. 31A and 31B provide a general view of the artery deformed by applanation;

FIG. 32 provides one example map of contact pressure in systole; and

FIG. 33 illustrates an example of a hand-held tonometer.

### Detailed Description

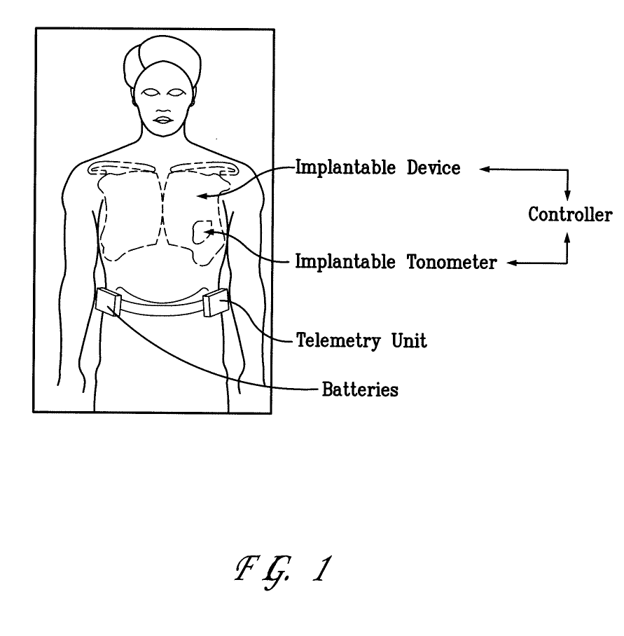

FIG. 1 is a block diagram of an exemplary implantable tonometer with an implanatable device such as a heart assist device, drug delivery system, pacemaker that provides real time feedback for closed-loop control. FIG. 1 also describes a method and implantable sensing system for monitoring and quantification of blood pressure and blood pressure waveform in real time with high accuracy and resolution.

The sensing systems may comprise an implantable sensor and actuator, and accompanying electronic signal conditioning, processing, transmission and power charging devices. The sensor system may deliver at least two types of data to the user: a standard absolute blood pressure and a blood pressure waveform. Standard absolute blood pressure may indicate the level of hypertension and the blood pressure waveform may provide information on the overall conditions of the cardiovascular system.

As shown in FIG. 1, the information from the sensor can be used internally to control various implantable devices such as a hypertension automated drug deliver system pacemaker, artificial heart, artificial pump, defibrillator and/or other devices. Externally, the information about the blood pressure may be transmitted to an actuators/users for manual drug administration, or as a warning signal, or can be transmitted to a doctor for medical intervention. The electronic systems secure appropriate reception, processing, analysis and transmission of blood pressure parameters to the target user.

The sensor system may include at least four basic sections: a transducer section, a fluidic section, an electronic section and a packaging section.

The pressure transducer section may include of a single or an array of piezoelectric sensors enclosed in the sensor head. The sensor head also may include a signal conditioning and processing unit, a wireless communication system and a power source. In other versions of the design, the signal conditioning and process unit, wireless communication system and power source can form a separate implantable unit integrated with the sensor head containing only a pressure transducer. The sensor head may be implanted on an artery of a patient for the purpose of a short or long term monitoring continuous or periodic measurement of blood pressure and blood pressure waveform.

The pressure transducers may be fabricated of piezoelectric material and operate in the double mode which includes the passive and the active pressure sensing. The sensors may be electromechanical resonant structures of different shapes such as bars, T-shape, forkshape, or disks, which the operating parameters such as resonant frequency or phase depends on the blood pressure.

An electronic device may be used to excite the pressure transducers into appropriate vibrational modes, measure the changes in the operational parameters of the transducers, correlate these changes with the blood pressure, and transmit the information on blood pressure to the user. The measured transducer changes include the changes in the amplitude, frequency and phase, in particular the resonant amplitude, frequency, and phase. The electronic section may be designed as a system of accompanying electric circuitry such as amplifiers, filters, and/or oscillators.

The external unit may secure the communication with the sensor head as well with a patient health care provider. The sensor response may be presented numerically or graphically on a panel display, and/or may be wirelessly transmitted to the users. It may also interface the sensor system with a microprocessor based system such a PC computer-based data processing, storage and display systems, and Internet-based communication and health systems.

A packaging section may be included to house the sensor and electronic units. The packaging sensor or housing may be made of biocompatible materials such as titanium, stainless steel, biocompatible polymers, poly(caprolactone) or poly(ethyl methacrylate) and poly(ethylene oxide).

The implantable blood pressure tonometer may be an implantable device that is intended to measure pressure or blood pressure in arteries, veins, gastrointestinal tract and lymphatic vessels. The sensor may be able to accurately measure systolic, diastolic and mean pressure as well as the whole blood pressure waveform in arteries and pressure in other lumens.

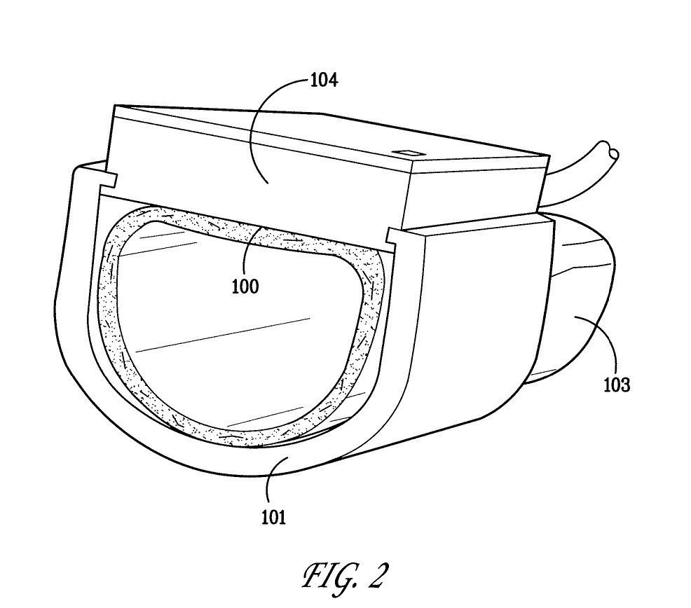

FIG. 2 is an enlarged isometric view of an exemplary implantable blood pressure sensor. As shown in FIG. 2, the implantable blood pressure sensor may comprises rigid sensor head 104 or multiple heads, rigid, semi-rigid or elastic support structure 101 attached to the sensor head by means of permanent or temporary connections.

The sensor head may comprise a rigid housing with a flat bottom portion and rounded edges 100. The flat bottom portion comprises a rectangular, oval or other elongated area, positioned in the center of the sensor head, on which the pressure transducers or an array of pressure transducers.

The sensors may be placed on the rectangular, oval or other elongated area, and are covered by a thin, rigid, semi-rigid or flexible membrane. The transducers placed on the sensor head measure a contact pressure between the arterial wall and the sensor head.

The rigid, semi-rigid or elastic support structure have dimensions and/or geometry which allows the sensing head to compress the artery decreasing the distance between the top and the bottom of the artery by 5 to 20% of arteries original size (outer diameter). The elongated area on which the transducer or transducers are placed is no wider than 10% of the artery diameter and the area ends no closer than 20% of artery diameter off the sensor head edges 100.

The sensor head stiffness expressed as a Young's modulus of a specific value, in particular, equal or higher than 1015 Pa. The sensor head 104 attached to the support structure 101 encompasses an artery. The flat portion of the sensor head compresses the artery. Although it is not shown, an array of force sensors is placed on the flat surface in the rectangular laying in the center of the sensor head and parallel to the artery axis.

The types of sensor, which can be used in such embodiment, are pressure or force sensors such as piezoelectric, piezoresistive, capacitive, optical, inductive or other.

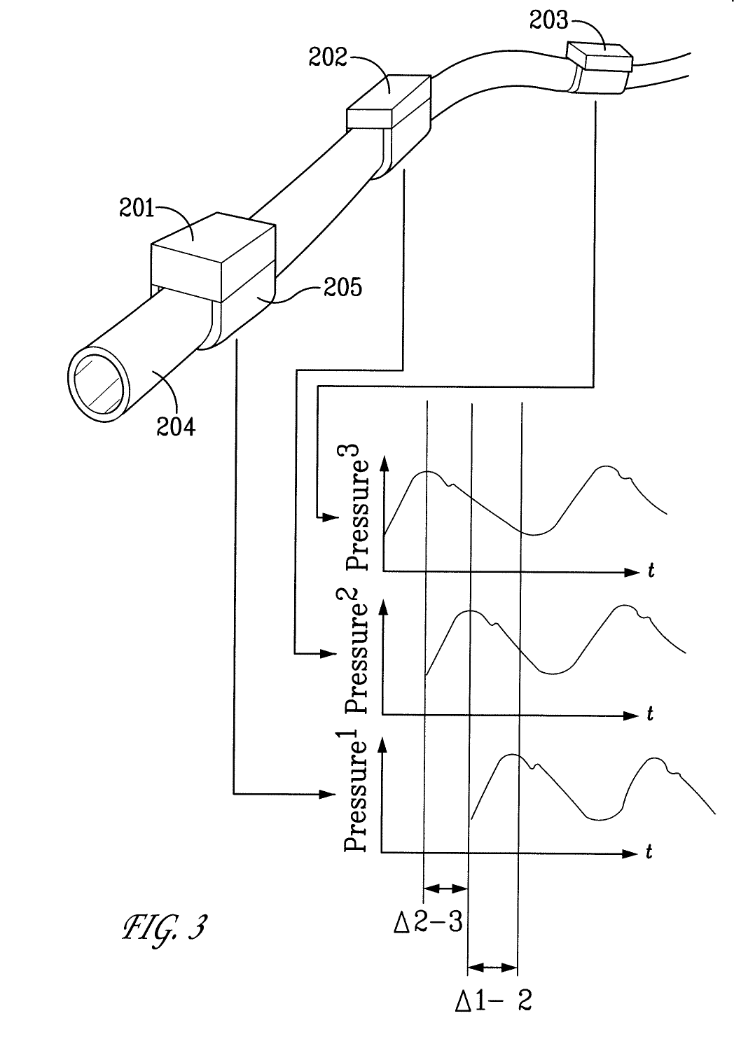

FIG. 3 depicts an array of the pressure transducers coupled to a vessel and their corresponding pressure versus time plots. The sensor comprises multiple heads 201, 202, 203 which are placed on the same artery 204 in certain intervals. In this embodiment the function of the sensor is enriched by a possibility of measuring the blood pressure pulse propagation velocity by measuring the time delay 01-2, A2-3. This property can be used to calculate vessel mechanical compliance.

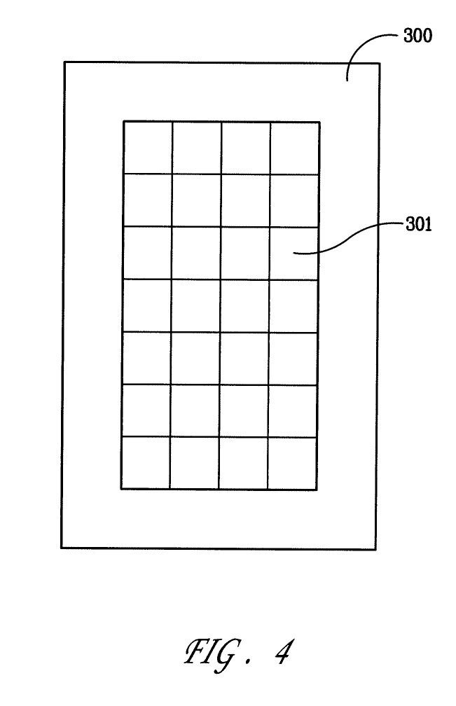

FIG. 4 is a view of the bottom part of a sensor head which comprises a plurality of pressure/force transducers. As shown in FIG. 4, the sensor is equipped with an array of transducers placed along the artery and across the artery covering the entire contact area between the sensor and the arterial wall. FIG. 4 shows the bottom part of the sensor head 300 with multiple pressure/force transducers 301. This sensor measures the contact pressure map between the sensor and the artery.

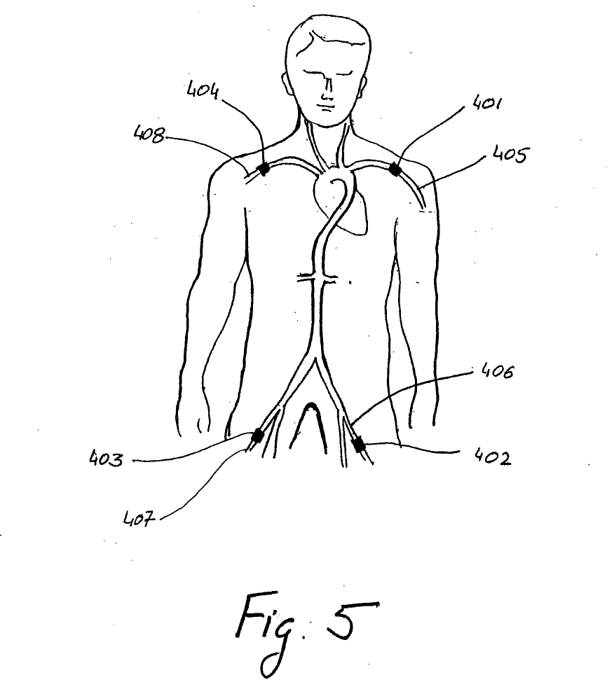

FIG. 5 depicts exemplary locations of a distributed sensor configuration that permits the measurement of blood pressure waveforms in various locations in the human body. This distributed sensor design comprises several sensors, 401, 402, 403, 404 and allows to measure blood pressure waveforms in various locations in human body on different arteries 405, 406, 407, 408. This design can measure time delay between pulses in various locations and can be used for artery stiffness measurements.

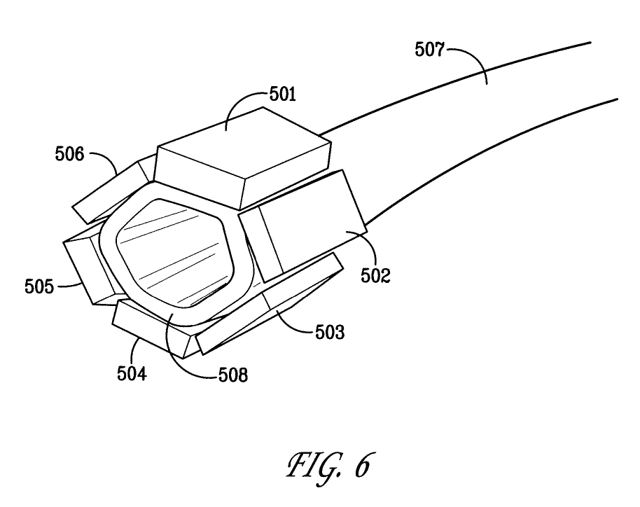

FIG. 6 depicts a sensor comprising several heads placed around a common artery. As shown in FIG. 6, several heads 501, 502, 503, 504, 505, 506 (two heads or more) placed around the same artery 507. The sensor exhibits superior reliability due to sensor head redundancy. The applanation of the arterial wall 508 is provided independently by each sensor head.

In some embodiments, the implantable tonometer may remain in human body for extended period of time (e.g., years).

In general, accuracy of blood pressure measurements may be determined by several factors, depending for example on sensor features as well as spectral content of the input signal. Dynamic response tells if the measurement system is capable of performing the particular type of measurements intended by a designer. For example, it is a known fact that the natural frequency of the system fₒ typically has to be higher than the frequency of the measured signal. Also, the amplitude and the phase characteristics of the signal typically should be flat in the working range of frequencies.

Three layers of tissue constitute the arterial wall: tunica intima, tunica media and tunica adventitia. They typically form the visco-elastic barrier between the pressure signal and the transducer. Thus the blood pressure signal may undergo distortion while propagating through this barrier. Moreover, inherent stresses to the arterial wall may affect the arterial blood pressure being transferred from the vessel lumen to the transducer as well. Both visco-elastic properties of the arterial wall and internal stresses are typically dynamic entities and are subject to change over time. The mathematical description that relates biomechanical properties of the arterial wall and electromechanical properties of the transducer to the input and output signals, allow for the prediction of the tonometer's response and, as a result, permit proper interpretation of the tonometer's readings.

Although the description is directed to a conduit that carries blood flow through a vessel, it should be appreciated that the embodiments contemplate additional conduits. For example, the embodiments may be directed to measuring fluid pressures in fluid conduits used in industrial settings. For example, the embodiments may be used to measure the pressure in various industrial pipe systems and have that information to be used as an input to warning systems, for process control, in hydraulic machinery, etc.

Also, the conduit may be a part of an anatomy beyond vessels. For example, the conduit may include an artery, vein, gastrointestinal tract, lymphatic vessel, urinary track, air track, and/or trachea. Various fluid characteristics may be measured including systolic pressure, diastolic pressure, mean pressure, and/or pressure waveform. Various characteristics of the pressure transducer may be monitoring including dynamic range, signal-to-noise ratio, and/or fluid pressure.

In addition, the embodiments may be used beyond just measuring fluid pressure or other characteristics. For example, the novel device and methods may be used as part of a vessel and/or cardiac bypass system. In these embodiments, the novel features may be a part of bypass unit that is manufactured and pre-arranged outside the patient's anatomy and later installed. For example, this may be used as part of a typical stent device, well known to those skilled in the art. The cardiac bypass system may correlates a response of the pressure transducer with a condition of a cardiac system. For example, for cardiac arrest, the transducer system may send a signal indicating that the patient is in cardiac arrest. A condition of the cardiac system may include flow obstruction, plaque accumulation, incoming heart attack, and/or drug management. Also, the collected information is communicated over the Internet to a health system, for example.

In one embodiment, where the system is assumed to be linear, is found in the form of a transfer function between the input and the output signals.

$${G}_{ij} = \frac{{S}_{i} ( s )}{{BP}_{j} ( S )}$$

where Gᵢⱼ is the transfer function, Sᵢ i-th is the output parameter, and BPⱼ is the j-th input parameter.

The tonometer is a device that works on the arterial wall. The measurand (arterial blood pressure) may be separated from the sensor by the biological structure-living tissue. This structure may not be uniform and may vary its biomechanical features depending on an individual, health and location.

Also, it is well known to those skilled in the art that some arteries may be prone to artifacts such as motion artifacts (e.g., those located in limbs) and hydrostatic error (locations above or below the heart). In addition, the anatomy of arteries may vary, reflecting their physiological functions. Some of these anatomical features may make the artery useless for implantation (e.g., the artery supplies blood to the large organ, and accidental damage of this artery by the tonometer can be dangerous for the subject).

Typical sizes of arteries are shown in the table below:

| blood vessel type | internal diameter range [mm] | wall thickness [mm] |
|---|---|---|
| aorta | 10-30 | 2-3 |
| main branches | 5-2.25 | 2 |
| large arteries | 4-5 | 1 |
| medium arteries | 2.5-4 | 0.75 |
| small arteries | 1-2.5 | 0.5 |
| arterioles | .0025-.01 | 002-.003 |

In general the arterial radius to wall thickness ratio may varies from 0.06 to 0.16. Typically, the arteries are divided into three groups: elastic arteries, muscular arteries and arterioles. This division may take into consideration major anatomical and functional characteristics

Elastic Arteries located in the aorta, iliac arteries, pulmonary trunk may carry all blood flow or its major part. Typically the tunica media of elastic arteries may consist of 40-70 layers of elastic fibers, alternating layers of circular oriented smooth muscle cells; tunica adventitia is thin. Elastic arteries, due to their high mechanical compliance, may work as a “shock absorber,” which absorbs and accumulates energy of the left ventricle contraction. Low concentration of muscle cells may make them good candidates for tonometry (e.g., constant visco-elastic parameters of the wall tissue), but they supply a majority of blood flow to the organs, thus they may be medically unacceptable as the implantation site. Also, the absolute radial pulsation of the artery, which is arterial radius change in response to the arterial blood pressure waveform may require large applanation to obtain stable measurement conditions.

Examples of radial pulsation include human (40-50 yrs) ascending aorta under pressure 124/80 mmHg, radial pulsation: ±3.3%, vessel OD: 16.4 mm; and uman (male av. 47 yrs) descending aorta under pressure 132/77 mmHg, radial pulsation: ±3.9%, vessel OD: 10.9 mm; and human (19-35 yrs) abdominal aorta under pressure 116/64 mmHg, radial pulsation: ±4.6%, vessel OD: 8.1 mm

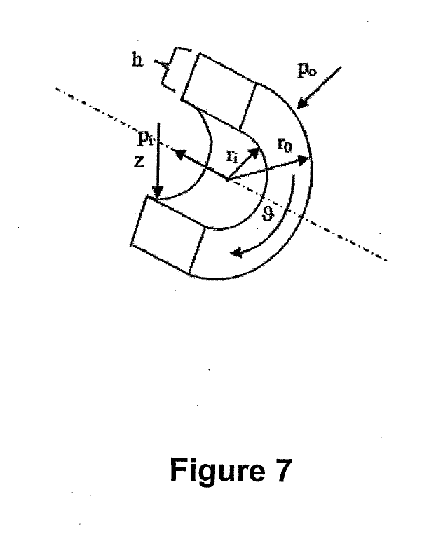

The arterial pulsation is caused by the fact that the alteration in the internal blood pressure may have to be compensated by the circumferential stress of the arterial wall. The increase in blood pressure generates an increase in circumferential stress, which leads to the strain adjustment according to Hook's law. The higher the mechanical compliance of the arterial wall tissue, the higher the strain response. The relationship between the vessel geometry and the transmural pressure may be governed by the following equation, which describes the equilibrium between blood pressure and circumferential stress. It points to the direct link between the circumferential stress and the transmural pressure:
T=hσ_{θ}=pᵢrᵢ−pₒrₒ
where: σ_{θ}—circumferential stress, θ—angle; pₒ—outer pressure; pᵢ—inner blood pressure; rᵢ—inner vessel radius; rᵢ—outer vessel radius; h—wall thickness. The equation may be valid even for non-homogenous, anisotropic materials such as arterial wall tissue. The variables and coordinate system are shown in FIG. 7.

Typically, the bigger the arterial pulsation the more difficult applanation, and the artery has to be compressed more in order to provide a stable flat region. The big radial pulsation eliminates elastic arteries as potential candidates for tonometer implantation. Muscular arteries that are located arising off the aorta may have their size range from 0.1 mm to 2.5 mm OD; relatively thick tunica media, mostly containing smooth muscle cells. The number of smooth muscle cell layers may vary from 4 (small arteries) to 40 (large arteries); tunica intima may be thinner than in elastic arteries. The function of muscular arteries is distribution of blood flow to various parts of the body.

In some embodiments, an interesting feature may be presented by one particular artery of this type: the mammary artery, also called the internal thoracic artery. This artery is easily accessible, using a small surgical procedure and even if damaged presents little risk to the subject. It is also remarkably resistant to cholesterol buildup. These particular features were utilized by heart surgeons in the coronary disease treatment before the bypass technique was introduced. Early surgical attempts tried to treat coronary heart disease by the direct implantation of the internal mammary artery into the myocardium. Their procedure is well documented and studied, assuring that the mammary artery can be safely used for the implantation procedure. In addition, the mammary artery lies in direct proximity of the aortic valve, which reduces the potential hydrostatic error, and the rib cage protects the device against motion artifacts.

Arterioles that are the smallest arteries branching from the muscular arteries may have a diameter that is less than 0.1 mm. Arterioles typically consist of 2-3 layers of smooth muscle cell; their function is blood pressure and flow regulation by changing the resistive component of local organ impedance. Because of the small diameter and high resistivity/pressure variations, these arteries they are not considered as being useful for tonometer implantation.

The potential tonometer implantation may be around the muscular artery, close to the aortic valve, preferably inside the rib cage. Those criteria are met by the intrathoracic muscular artery-mammary artery. This target muscular artery is 1-5 mm OD and has the wall thickness around 10% of the overall arterial outer diameter (OD).

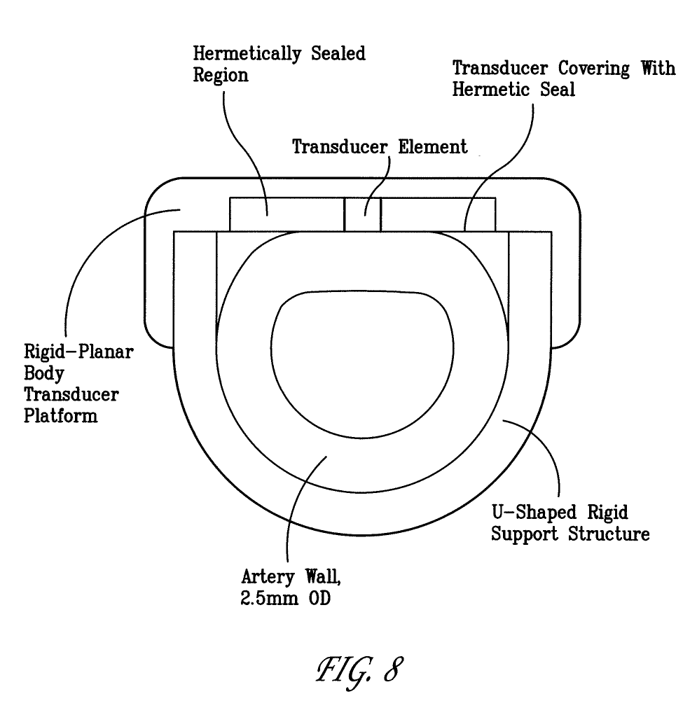

FIG. 8 illustrates the implantable tonometer concept utilizing the intrathoracic artery. Different types of arteries may differ between themselves. The arterial geometry such as arterial OD and the wall thickness may depend on the artery type. Also, thickness of the arterial wall internal layers may depend on the artery type. On the other hand, some features are common for all arteries. The layer structure is an example of such a feature.

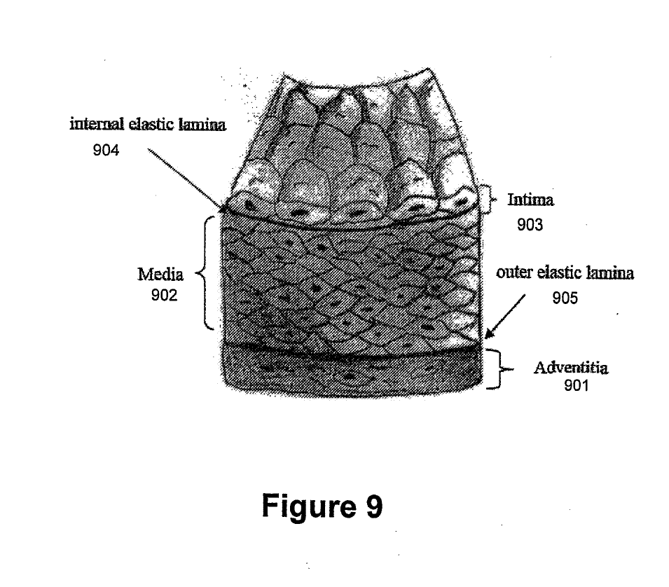

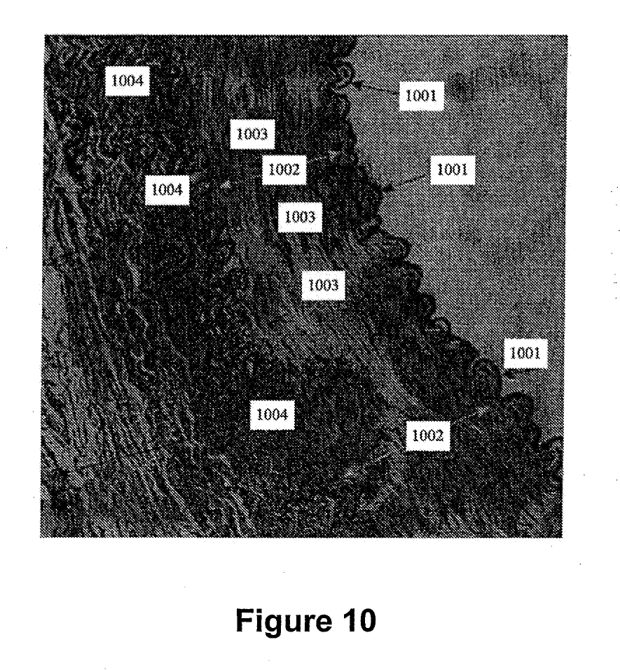

FIGS. 9 and 10 illustrate typical arterial wall segment. The arterial wall may consist of three layers: adventitia 901, media 902 and intima 903. The demarcation line between tunica media and tunica intima is an internal elastic lamina 904 made of fenestrated membrane of elastin lined on the intimal side by a coarse fibrous network. The outer elastic lamina 905 demarcates the tunica adventitia 901. Arterial wall tissue consists mainly of collagen and elastin fibers, which surround smooth muscle cells. Three arterial wall layers may have a significantly different structure and composition, as shown in FIG. 9 and 10.

FIG. 10 provides an arterial wall cross section. Three layers of tissue are shown: tunica intima 1001, tunica media 1002, external elastic membrane 1003, and tunica adventitia 1004.

Tunica adventitia 1004 is mostly fibrous (mostly collagen and small quantities of elastin) and anchored in surrounding connective tissue. The adventitia and media usually are penetrated by the mesh of smaller arteries (vasa vasorum) that supply blood to the smooth muscle cells. Tunica adventitia is mostly made of fibers, and its outer border is sometimes not well defined, and transition between adventitia and surrounding connective tissue is gradual.

Tunica media 1002 is a major determinant of the arterial wall mechanical properties. It is made of collagen and elastin fibers and smooth muscle cells. For example, the fiber composition in the upper part of the aorta is ˜70% elastin and ˜30% collagen. Below the diaphragm the composition changes to 40% elastin and 60% collagen, which makes media stiffer. The elastin and collagen fibers may form layers running circularly or in a tight helix. Between those layers lay smooth muscle cells. The smooth muscle cells make the media an active mechanical element, which may be governed by biochemical elements (e.g. hormones ) as well as sympathetic and parasympathetic nervous systems. Smooth muscle cells form a spiral structure, mostly parallel to the elastin, around the lumen, while elastin and collagen form a three dimensional network. Under the physiological pressure, the elements (elastin, collagen and smooth muscle cells) may form well-defined layers.

Tunica intima 1001 may consist mainly of endothelial cells and may be a barrier between blood and the arterial wall. Endothelial cells of tunica intima are flat cells, and their shape and pattern may depend strongly on shear stresses generated by the blood flow. Tunica intima typically contributes little to the overall mechanical properties of the arterial wall, although mechanical stress and strain (e.g. applied by the shear stress generated by the blood stream) may strongly affect cellular structure and function.

A complicated structure of the arterial wall (e.g. collagen and elastin networks and their connection to the smooth muscle cells) may be responsible various ways to describe the arterial wall visco-elastic properties using a whole spectrum of models and visco-elastic parameters. The strong variability of parameters, such as composition of collagen and elastin and smooth muscle cells concentration along the arterial tree, or among different age groups, as well as between species, may make the task even more difficult. As a result, mechanical properties of any target artery may not be able to be expressed as a set of constants. Arterial wall parameters may vary with age, subject physiological status, disease, etc. Some parameters may vary in short periods (e.g. smooth muscle cell tension), while some change over a long period of time and represent specific drift of mechanical properties (e.g. collagen-elastin composition or calcification of tissue).

Thus, the mechanical properties may be treated as parameters characterized by their range and an average value. The values, which are used in simulations and calculations, may be defined based on the literature and, if it is possible, the whole range of physiological values is used. The literature typically presents numbers or range of values: statistical median for population or the center value of the known physiological range. It may be necessary to note that those numbers may be difficult to validate because many of them are given without information about how they were obtained (in vivo, ex vivo, in situ, etc.) and about the population from which the sample was drawn. Also, some arteries may attract more attention from the scientific community due to the fact that they are closely related to popular diseases or treatment (e.g. aorta, coronary arteries, and carotid arteries). In contrast, some vessels may be barely described in the physiological literature.

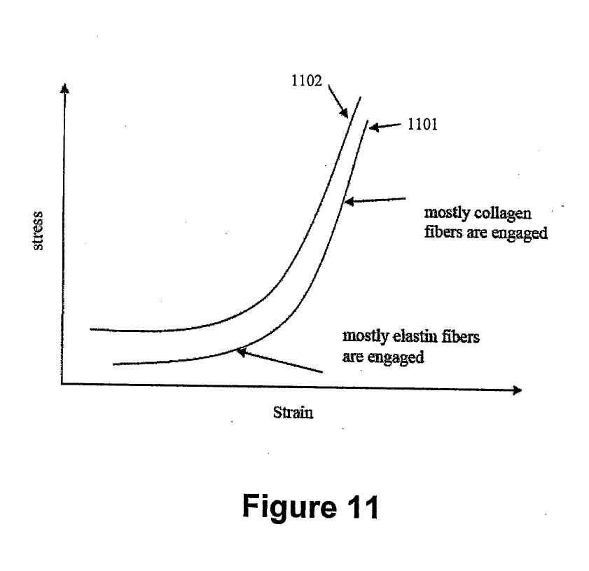

Generally speaking, the arterial wall is not a Hookean material, as is well known to those skilled in the art. The elastic modulus may not be defined as a set of constants. Due to the fact that lower stress engages mostly elastin fibers (higher mechanical compliance) and higher stress starts to recruits gradually more collagen fibers (lower mechanical compliance), the stress-strain relationship for the arterial wall tissue may be far from linear, as shown in FIG. 11. FIG. 11 illustrates the generic relationship between stress and strain in the arterial wall tissue. As shown in FIG. 11, curve 1101 corresponds to relaxed smooth muscle cells, and curve 1102 to activated smooth muscle cells. The additional stress may be introduced by the activated smooth muscle cells. The smooth muscle cells may shift the stress-strain relationship curve as shown in FIG. 11.

Nevertheless, there may be some specific numbers for Young's modulus assuming that under particular conditions the arterial wall is a Hookean and isotropic material. As a commonly accepted practice to those skilled in the art, the living arteries under physiological load (i.e. blood pressure pulse) may be treated as the Hookean isotropic material governed by Hook's equation, as follows:

$$[ \begin{matrix}{σ}_{xx} \\ {σ}_{yy} \\ {σ}_{zz} \\ {σ}_{xy} \\ {σ}_{xz} \\ {σ}_{yz}\end{matrix} ] = \frac{E}{( 1 - 2 v ) ( 1 + v )} \times [ \begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1 - 2 v}{2} & 0 & 0 \\ 0 & 0 & 0 & 0 & \frac{1 - 2 v}{2} & 0 \\ 0 & 0 & 0 & 0 & 0 & \frac{1 - 2 v}{2}\end{matrix} ] [ \begin{matrix}{ɛ}_{xx} \\ {ɛ}_{yy} \\ {ɛ}_{zz} \\ {ɛ}_{xy} \\ {ɛ}_{xz} \\ {ɛ}_{yz}\end{matrix} ]$$

Or, in short form as follows:
[σ]=[D][ε]

Therefore, in some embodiments two parameters may be commonly used to characterize the static mechanical properties of the arterial wall: Young's modulus E and Poisson's Ratio v. Young's modulus in systemic arteries working under physiological conditions is from 2.0 to 8.0×10⁶ dyne/cm² and Poisson's ratio is approximately 0.5 for incompressible material when material property matrix D in the above equation becomes singular. In addition, sometimes the bulk elastic modulus may be given 2.2×10¹⁰ dyne/cm², 4.4×10⁹ dyne/cm².

Bulk modulus is very often overlooked, but in some embodiments its importance may be undeniable. In tonometric measurements the majority of the blood pressure energy is transferred to the sensor by the perpendicular to the arterial wall compression of the tissue, therefore, the bulk (compressional) modulus may play an important role. Utilization of a low compliance transducer may even increase bulk modulus importance. Bulk modulus of the artery is 2.2×10⁹ N/m², which is close to bulk modulus of water equal to 2.05×10⁹ N/m². These calculations are based on the assumption that the arterial wall contains 70% water.

Average arterial wall bulk modulus may be 4.2×10⁸ N/m². Assuming the arterial wall is being compressed by physiological transmural pressure of 120 mmHg, 15 996 Pa (i.e., systolic value for a healthy individual), the change in artery wall thickness will be equal to 7.3×10⁻⁶ fraction of the wall's original volume. Assuming arterial wall thickness of 1 mm and only radial changes, the overall compression of the arterial wall will be 7.3×10⁻⁹ m. For traditional transducers, where the device was working with the sensing mechanism displacement close to 0.15 mm, artery wall thickness changes may be negligible. In other words, the difference between transducer deflection and wall thickness compression is 5 orders of magnitude-wall thickness compression is roughly 10⁵ times smaller than the transducer deflection.

On the other hand, the Young's modulus of PZT, used as a transducer may be 4.4×10¹⁰ N/m². Thus using a PZT type of transducer, one may expect that arterial wall compression will be comparable to transducer displacement. This “inversion” of stiffness ratio may introduces new issues.

The static description of the artery may not be enough to describe the mechanical response of the artery to the dynamic stimulus such as blood pressure pulse. The elastic real modulus may be substituted with a complex elastic modulus, capable of describing energy dissipation in the arterial wall tissue. The complex modulus also may describe frequency dependent behavior. The arterial structure by nature dissipates energy by being a viscous material. The value of the viscous component of visco-elastic modulus of the tissue depends on the applied model. For example, in some embodiments, the visco-elastic modulus may be:
E′=E+jμω
where E is the real part of the modulus (Young's modulus), μ is viscosity and ω is frequency. The viscosity for such model may be approximately 1.2×10⁶ dyne/cm². In real tissue the viscosity may be highly frequency dependent and decrease with frequency (in arterial tissue ωμ grows to 2 Hz and then stays constant with increasing frequency).

A broad range of problems involved in the implantable tonometer measurement process may require a variety of modeling and analysis techniques. For example, the measurand conversion from the intralumenal pressure to the tonometer response may be simulated using a concept of mechanical system transfer function. This technique may answer the question of how the biomechanical system converts applied pressure to the transducer element displacement. The result may be the tonometer's transfer function in frequency domain.

The linearity and error of the implantable tonometer may be studied using a lumped parameter model, where the input and output signals are compared in time and frequency domain. The model may take into account typical biomechanical parameters of the muscular artery (i.e. Young's modulus, and viscosity) coupled with the tonometer sensor head equipped with a piezoelectric transducer. This analysis may compare typical physiological input (e.g., blood pressure waveform recorded in the human aorta) with the tonometer's output. The model may help to understand the inherent nonlinear behavior of the tonometer working on the arterial wall and allow studying optimal configuration to minimize the nonlinear response.

The simulations may be performed for the range of transducer's Young's moduli. The outcome of this analysis may determine the range for the tonometer's Young's modulus in which the measurements are linear and fall into an assumed accuracy range.

The detailed biomechanical interface and arterial wall phenomena may be modeled by a Finite Element Method (FEM). This method may model the contact pressure distribution on the interface between the tonometer and the artery as well as the stress and strain map inside the arterial wall. The simulation may be four-dimensional (3 dimensions plus time) and reveal a complex nature of the interface phenomena. The contact pressure map may be presented and analyzed as well as stress-strain inside the arterial wall to determine how the applanation changes the natural arterial wall stress-strain distribution.

One of the goals of tonometer modeling may be to build a mathematical description of the measurement process, i.e. a set of equations describing how the arterial blood pressure signal is transmitted from the artery lumen to the output voltage signal. The numerical solution to this set of equations may provide information about the system response to different working conditions, such as different elastic modulus of the arterial wall and viscosity (E_{wall} and η), as well as different mechanical compliance of the transducer, which transfers to different elastic modulus of the whole transducer-E_{Tr}.

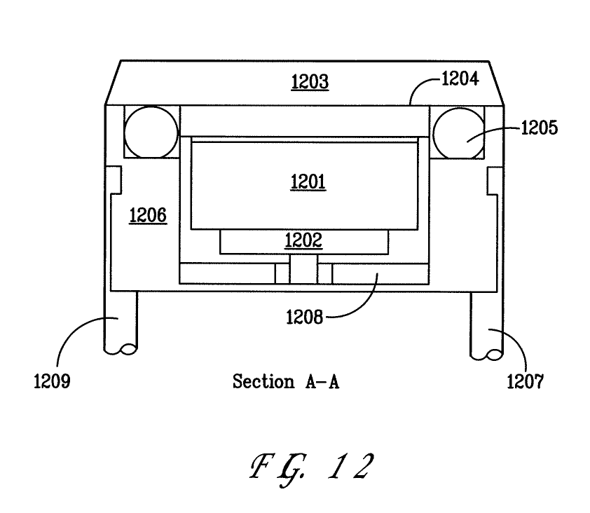

FIG. 12 illustrates a cross-section of the implantable tonometer for a generic tonometer structure. As shown in FIG. 12, force transducer 1201, pin 1202, stainless steel housing 1203, 1206, rubber layer generating prestress 1204, O-ring 1205, U-shape supporting structure 1207, stainless steel washer 1208, and arterial wall 1209. An arrow pointing down indicates a thin wall of a stainless steel housing.

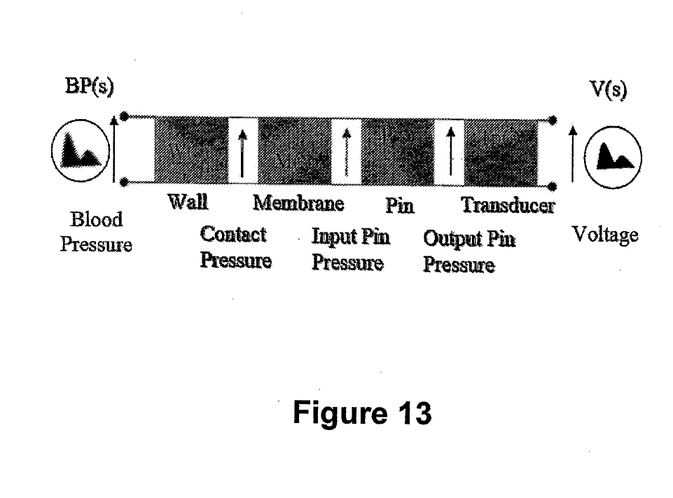

The implantable tonometer is intended to reproduce a shape of the waveform, which may be equivalent to a spectrum in frequency domain. The measuring process may take several steps and start from the blood pressure waveform (called a BP(t) signal or an input signal) and end on the output voltage signal, as shown in FIG. 13. FIG. 13 illustrates a conceptual model of the tonometer's sensing path, where the up arrow represents signals, and blocks represent transfer functions of each functional element of the tonometer.

Each of the measurement steps introduces a specific disturbance in time and frequency domains. In order to reconstruct properly the parameters of the blood pressure input signal from the output voltage, it may be practical to know the transfer function of the sensing path. Although the concept of transfer function may be applicable to linear time-invariant systems and tonometry faces serious non-linearity, especially during the signal transfer through the arterial wall. Moreover, it is a time varying system due to aging and activity of the smooth muscle cells: vasoconstriction and vasodilatation. In some embodiments it may be possible for small transducer displacement, low frequency, and stable inherent wall stresses. The transfer function concept allows making the design process more efficient and demanding less-complicated calculations in early stages of the sensor development.

The corresponding transfer function equations (in s domain) for the sensing path may be:

$$BP ( s ) W ( s ) M ( s ) P ( s ) Tp ( s ) = V ( s )$$

$$G ( s ) = \frac{V ( s )}{BP ( s )} = W ( s ) M ( s ) P ( s ) Tp ( s )$$

where: BP(s) is a blood pressure signal, W(s) is wall transfer function, P(s) is the pin transfer function, Tp(s) is transducer transfer function, V(s) is voltage output, G(s), overall tonometer transfer function.

In order to simulate the blood pressure signal transfer through the arterial wall a lumped parameter, mechanical model may be built. This part of the measurement process is represented in FIG. 12 by the block W(s). It may be a first step of the measurement process. The input BP(s) signal-blood pressure may be transferred to CP(s)—contact pressure between the arterial wall and the tonometer's head. To obtain W(s) transfer function, one may express the conversion from blood pressure to contact pressure BP(s)->CP(s) as a linear process. The necessary assumptions for linearization may be made as well as justification for the linearization process is discussed.

There are many types of membranes that may be used in the tonometer design. The membrane typically is designed to introduce minimal or no disturbance between the forward and backward pressures. It is usually achieved by very large mechanical compliance and small mass. Because this work is not to study the technicalities of various types of membranes, the membrane may be assumed to be an ideal membrane with little influence on tonometer performance. The generality of the study may be preserved even if the membrane will not be ideal due to the fact that mechanical properties of the membrane may be incorporated in transducer properties and expressed in effective mechanical parameters of the sensor head.

The pin between the transducer and the membrane may be considered to be a simple pressure divider. Although the mass of the pin may introduce inertia that contributes to the phase shift between the input and output signal and the resonant frequency of the system, it may be easier, without losing accuracy, to include this mass into the sensor head effective mass.

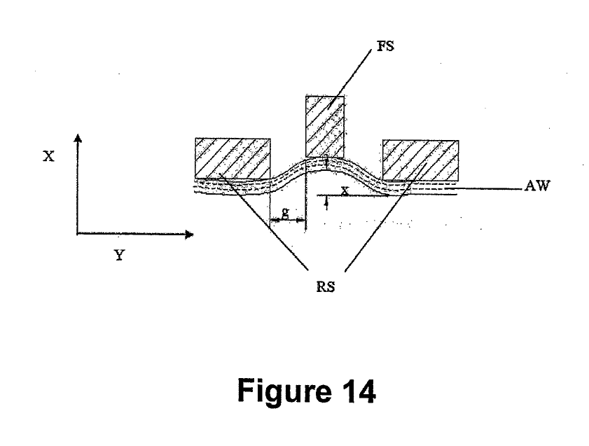

FIG. 14 provides a general layout of a two-dimensional tonometer-arterial wall biomechanical system. As shown in FIG. 14, an arterial wall under applanation may have a gap between the force transducer and the rigid body g and the amplitude of deflection x. AW represents arterial wall, RS rigid structure of the sensor head and FS represents force sensor transducer.

The applanation may be achieved by compressing the arterial wall by the rigid structure (RS), and the force sensor (FS) is positioned in the middle of the rigid structure. The g is a gap between the force sensor and the rigid structure. Blood pressure compresses the arterial wall, deflecting the force sensor by distance x. Because force sensors undergo a deflection during the measurement process. Assuming that the border conditions do not allow the arterial wall any motion parallel to the rigid structure (in Y direction), the arterial wall may be stretched in order to transfer blood pressure to the force sensor (FS).

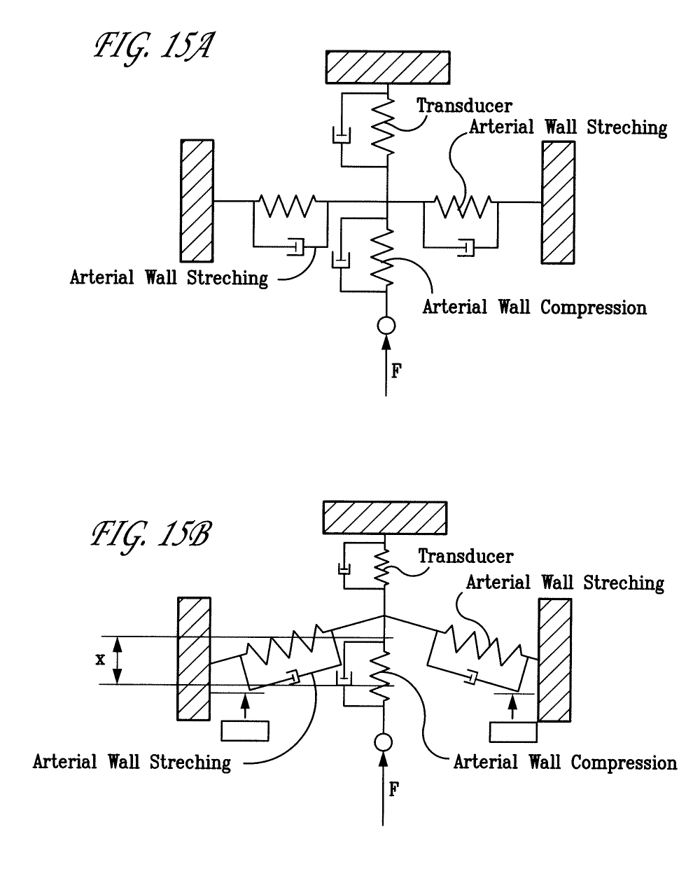

Both transfer function as well as the dynamic response of the system may be obtained by simulating the arterial wall—tonometer system using a lumped parameter mechanical model, as shown in FIGS. 15A and 15B. FIGS. 15A and 15B illustrate a conceptual model of arterial tonometry. FIG. 15A shows applanation without blood pressure applied (F=0), FIG. 15B shows transducer deflected by the force generated by the blood pressure representing transducer is compressed. Forces generated by arterial wall stretching introduce nonlinearity in transducer's reading due to angle a between stretched arterial wall and the force F generated by the blood pressure.

This model is established on a spring-dashpot concept. The spring-dashpot system addresses the problem of dynamic response of the tonometer working on the visco-elastic arterial wall. The model contributes to the general understanding of the measuring process and helps with building the tonometer's sensing path. The system is built of spring-dashpot linear elements that represent elastic and viscous properties of the living tissue and the tonometer. The spring is responsible for simulating a Young's modulus (potential energy accumulation) and a dashpot represents dumping properties (i.e., energy dissipation). This configuration of elements is known by those skilled in the art as a Voigt model and its response to the mechanical stress is described by the following equation:

$$\frac{Δ L}{L} = \frac{T}{E} ( 1 - {ⅇ}^{Et / μ} )$$

where T is stress, L length of the Voigt element, ΔL change in length, E elastic modulus, μ is viscosity, and t is time.

FIGS. 15A and 15B shows that the Voigt elements simulate longitudinal and perpendicular to the acting force properties of the arterial wall and the longitudinal (compressional) properties of the transducer. The force F is generated by the blood pressure pulse BP(t). In FIG. 15A, the undisturbed tonometer—arterial wall system is depicted (no pressure applied). The transducer is not compressed and the arterial wall stays undisturbed. In FIG. 15B, the blood pressure generates force F>0 and compresses the arterial tissue, stretches it and consequently compresses the transducer. The springs represent longitudinal and perpendicular elastic modules and the dashpots longitudinal and perpendicular viscous behavior.

In this model the F is BPⱼ input parameter and the displacement x is Sᵢ output parameter. Although, the spring dashpot subsystems may be linear, the overall system may represent strong non-linear properties due to arterial wall stretching that acts under certain angle α determined by F.

Because the in-vivo and in-situ analysis of the biomechanical phenomena taking place during the tonometric measurement process, particularly those within the volume of the arterial wall, may be difficult, the numerical analysis, such as finite element modeling approach, may be facilitate gaining the basic understanding of this part of the tonometry sensing mechanisms. To model the complicated behavior of the tonometer-arterial wall interface (contact pressure) and the stress inside the arterial wall the finite element model may be used.

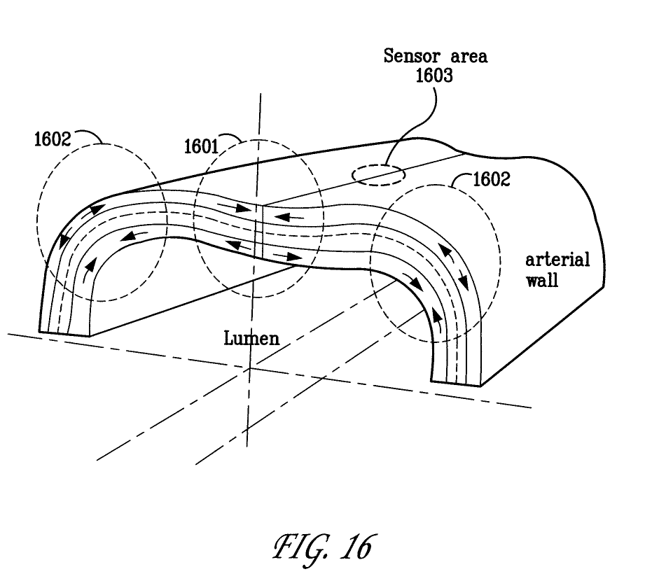

FIG. 16 illustrates a stress in flattened artery. As shown in FIG. 16, a central region of flattened wall (region 1601), external layers are compressed and internal stretched. In comers of U-shaped structures (region 1602), stress distribution may be opposite. Circular dashed region shows the position of tonometer's sensing area 1603.

The model reproduces applanation geometry: the artery is encircled by the tonometer. The tonometer may consist of the U-shaped support structure and the sensor head. The artery inside the tonometer may be represented by a mash of elastic elements. The model may be subjected to the loads simulating arterial pulse pressure and the load generated by artery compression during applanation. First, the applanation load may be applied and then the pulse may be built as a series of static loads. The output may be stored as a complete map of stress and strain recorded in the model's nodes. This map is subsequently used for further analysis.

In general, a non-linear relationship between a circumferential stress and strain may be observed in real arterial tissue. This relationship and, for the linear approximation, the equilibrium equation discussed above may determine the mechanical behavior of the free artery.

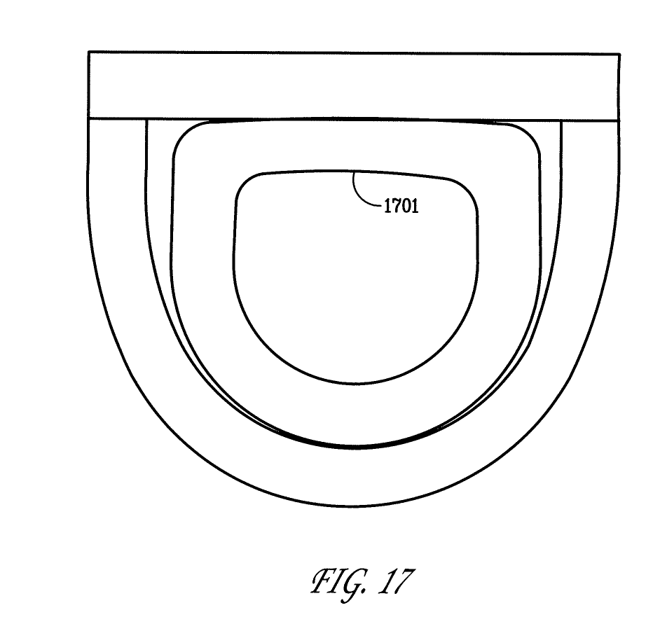

In contrast, if the artery is flattened by the tonometer, the natural circumferential stress is disturbed and an additional stress is introduced. The situation is shown in FIG. 16 where the flattened portion of the artery is depicted. Considering the central part of the flattened artery (1601 region in FIG. 16), the superficial layer may be compressed, as indicated by arrows, and the deep layer may be stretched. The tissue in the comers of the tonometer support structure region (1602 regions in FIG. 16) may undergo reversed stress distribution. The additional stress may modify the flattened artery geometry by introducing unbalanced forces, and buckling the artery toward the lumen. As shown in FIG. 17, preliminary studies using the silicon mock arteries, have suggested this kind of behavior.

FIG. 17 shows a buckling phenomena 1701 occurring in the center of the applanation region. As shown in FIG. 17, applanation does not generate a flat region in which the stresses are perpendicular to the arterial blood pressure, as would be expected based on the classic tonometry theory. Instead, the arterial wall generates a complicated pattern of stress and strain distribution. Therefore, the numerical simulation is conducted, and the stress and train map recorded in model nodes is stored for further analysis.

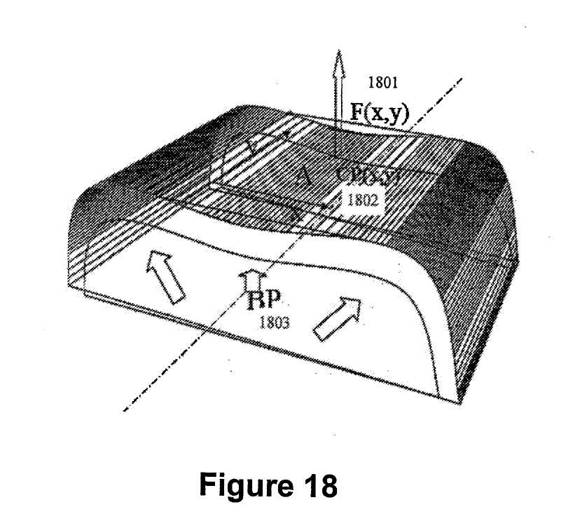

The buckling effect affects not just the stress inside the arterial wall but also may effect the contact pressure. The contact pressure may be a direct input for the tonometer sensor head, therefore, the understanding of the contact pressure nature and its relation to the blood pressure is critical to the overall measurement process. The finite element model maps the stress distribution and calculates the contact pressure, thus the blood pressure signal can be related to the contact pressure, as shown in FIG. 18.

FIG. 18 illustrates contact pressure on a flat portion of artery. As shown in FIG. 18, the wall produces force F(x, y) 1801 per area A, which is contact pressure (CP) 1802. To calculate this pressure the FEM simulation and integration over the area A may need to be performed.

The contact pressure acting on the sensing element may not be uniform and may vary along x and y axes. In general, force F 1801 acting on the transducer may be expected to be a function of x, y, and time, as follows:

$$F ( t ) = A {\int }_{x} {\int }_{y} CP ( x , y , t ) ⅆ x ⅆ y ;$$

$$Where \text{:}$$

$$CP ( x , y , t ) = CP [ BP ( t ) , x , y ] ;$$

where A is a contact area between the tonometer and the arterial wall, CP contact pressure, and BP 1803 blood pressure signal. As a result, a relationship between BP(t) 1803 and F(t) 1801 (i.e., the actual tonometer input signal) may demonstrate a much more complicated nature than that predicted by the traditional theory.

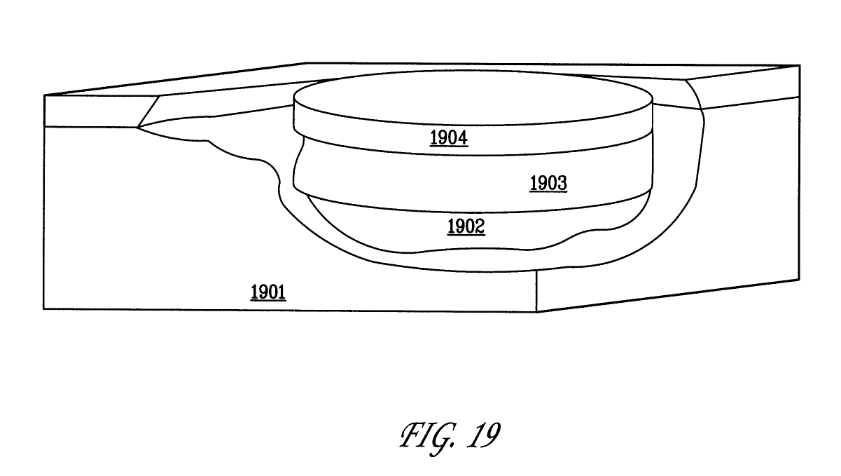

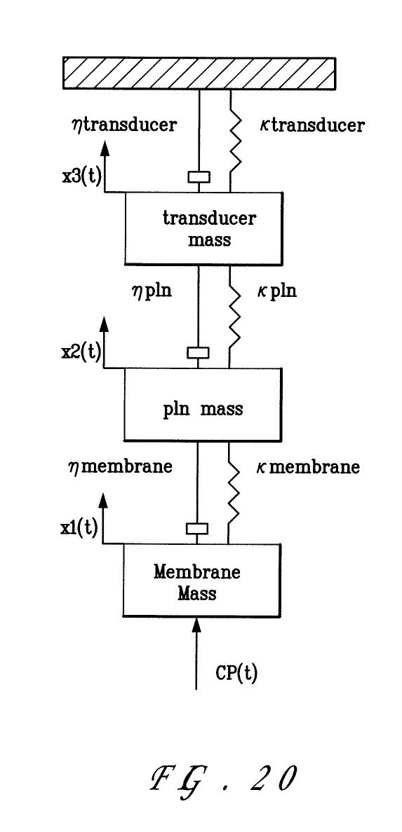

FIG. 19 illustrates a target design of the sensor head. As shown in FIG. 19, the sensor head includes a membrane 1901, pin 1902, piezoelectric transducer 1903 and elastic support 1904. The elements may be considered to be linear time invariant systems (in terms of transferring mechanical stress). Therefore, they can be represented by a spring dashpot linear system, as shown in FIG. 20.

Simplifying the system to one mass, a dashpot and a spring element may be justified in some embodiments because of the fact that the sensor head includes several linear subsystems. As a result, it may be considered to be a series of linear systems as a cumulative, mass, elasticity and dumping factors. The systems may be calculated using parameters of elements, shown in FIG. 20.

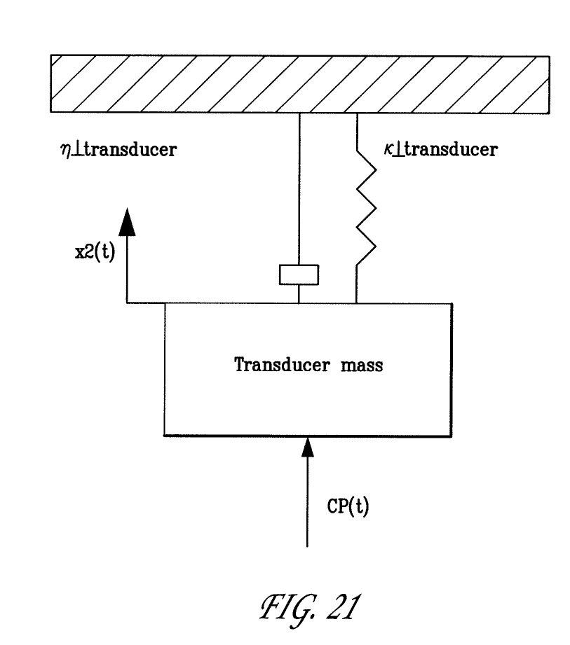

FIG. 21 illustrates the equivalent simplified “spring-dashpot” model. As shown in FIG. 21, the model may not include nonlinear factors since the acting force is parallel to the spring-dashpot system. Corresponding equations may be:

$${M}_{Tr} \frac{ⅆ {}^{2} x ( t )}{ⅆ {t}^{2}} = - {k}_{Tr} x ( t ) - {η}_{Tr} \frac{ⅆ x ( t )}{ⅆ t} + CP ( t ) ;$$

$$\frac{ⅆ x ( t )}{ⅆ t} = v ( t ) ;$$

where MTr is transducer mass, x transducer displacement, kTr transducer elasticity, ηTr transducer viscosity, CP contact pressure, and v(t) velocity of the transducer displacement. With the simplified sensor head representation, a transfer function may be calculated. The transfer function between the force and the effective mass displacement (force sensor deflection) x(t) may be given by:

$$\frac{X ( s )}{CP ( s )} = \frac{1}{{Ms}^{2} + η s + {k}_{Tr}}$$

where M, η, and k are respectively: effective mass, effective viscosity, and effective elasticity.

Effective parameters may be calculated for PZT transducer's mass=0.05 g, pin mass=0.01, membrane mass=0.001 g, PZT η=6 dyne/cm², Stainless steel η=1 dyne/cm², rubber η=7 dyne/cm², PZT k=4.4×1011 dyne/cm², Stainless steel k=19.5×1011 dyne/cm², and rubber k=0.23×1011 dyne/cm².

The sensor head can be represented as a linear system because it consists of several linear subsystems arranged in a series, thus the equivalent system can be derived and subsequently the transfer function of it can be calculated. The sensor head mechanical model may be subsequently converted to an equivalent model which includes a spring, dashpot, and mass elements representing effective values.

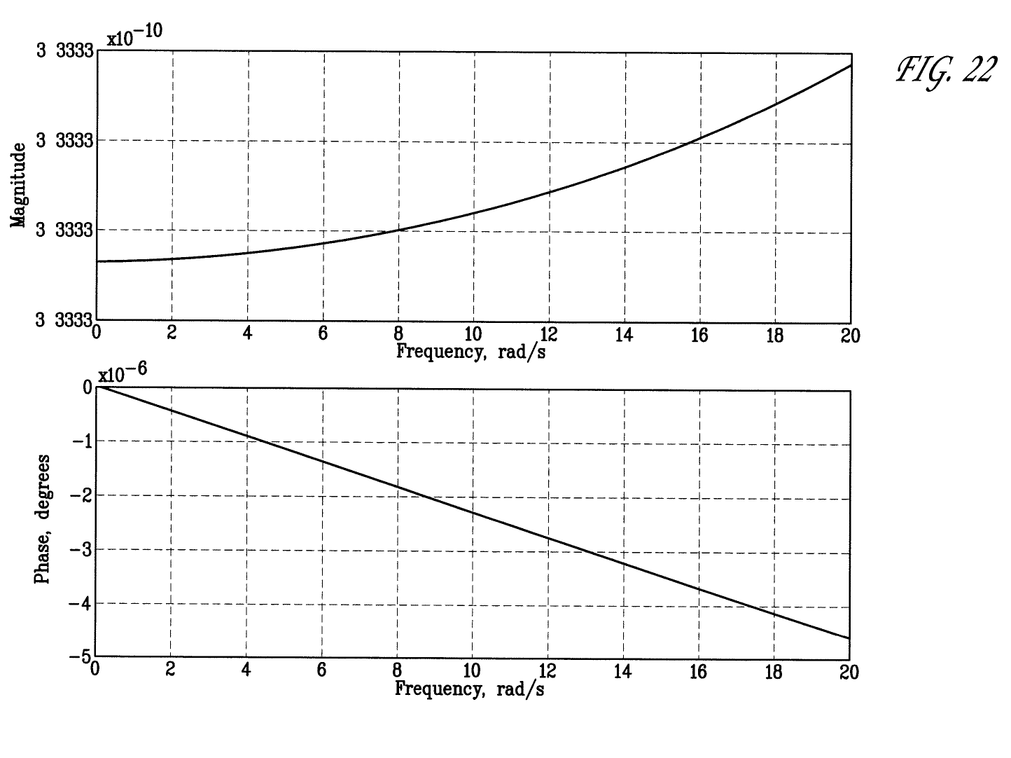

FIG. 22 is a graphical illustration of a sensor head transfer function showing magnitude and phase. As shown in FIG. 22, a relationship between a force generated by the contact pressure and the sensor displacement in terms of sensor head transfer function. The magnitude of s₂₁ parameter is almost constant and phase also changes by 5×10⁻⁶ degrees in a frequency range from zero to 20 rad/s (˜6.36 Hz). For blood pressure measurement, this type of change may be negligible (e.g., order of 10⁻¹⁰ in magnitude and 10-6 in phase). Mechanically, the sensor head can be considered as an element that does not introduce any change to the input signal.

A lumped parameter model presented may simulate dynamic properties of the arterial wall under applanation, sensor head, and the overall system (sensor head coupled with the arterial wall). Initially, analysis of the arterial wall may be performed to show nonlinear behavior of this part of the measurement system, and then the process may be reconstructed to find out how the nonlinearity can be minimized by changing sensor head mechanical compliance. The analysis may be performed with the typical input signal recorded in the human aorta. The aortic pressure may be decomposed into harmonics and the first five of them for example may be used in calculations. The remaining higher harmonics may be omitted for clarity's sake and due to the fact that they carry a minute amount of signal energy and their contribution to the measurement process is negligible.

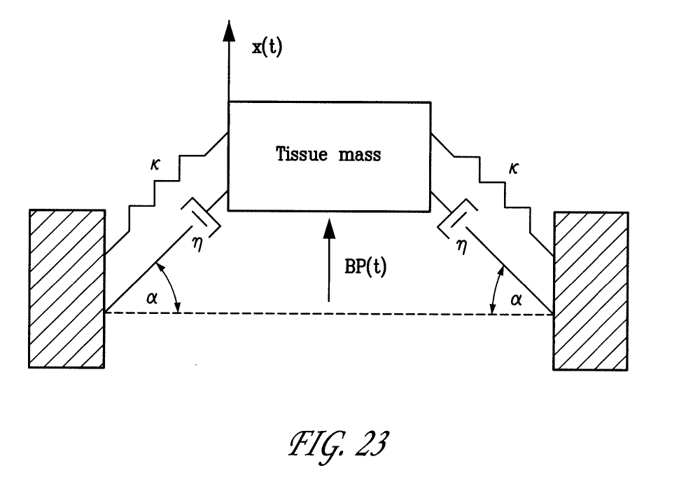

FIG. 23 illustrates a spring-dashpot model of the arterial wall under applanation and undergoing deformation due to the arterial blood pressure BP(t), where k is elastic constant, η viscosity, BP blood pressure, and x transducer's displacement. As shown in FIG. 23, with a lumped parameter model of the arterial wall under applanation, there are basic features of the arterial wall biomechanical system. The spring may represent the elastic modulus of the arterial wall while the dashpot simulates wall tissue viscosity. The mass of the arterial wall may be simulated by the effective mass concentrated in the center of the system, between two Voigt type elements.

It also may be necessary to model the mechanical properties of the arterial wall tissue. The arterial wall model may be employed in the dynamic response lumped parameter simulation takes into consideration two fundamental features of the human tissue: elastic modulus and viscosity. Both parameters may constitute the complex visco-elasticity:
E′=E+ηωj
where E′ is a complex viscoelastic modulus consisting of E, the Young's modulus, and ηω is the viscous loss component. The equivalent mechanical model for this type of viscoelasticity may be a spring and dashpot arranged in parallel. Because in the presented simulation the tissue undergoes small strains and the input signal consists of low frequency harmonics (0-20 Hz), the model may assume E and η to be constant. This lumped parameter model does not take into consideration the three-layer structure of the arterial wall and may not include changes in E′ due to smooth muscle activity. Therefore, it may be more valid for the large vessels such as the aorta, where the smooth muscle concentration in tunica media may be lower then for muscular arteries where smooth muscle cells are higher in number.

Nevertheless, this approach may allow the building of a relatively simple dynamic models and study the dynamic behavior of the biomechanical and mechanical components of the tonometer system. The model shows mechanical arrangement and relations between the input signal (intraluminal arterial blood pressure BP(t)) and the arterial wall displacement x(t). This model is a simple non-linear oscillator described by the following system of equation:

$$M \frac{ⅆ {}^{2} x ( t )}{ⅆ {t}^{2}} = - 2 k sin ( α ) ( \sqrt{{g}^{2} + {x}^{2} ( t )} - g ) - 2 η sin ( α ) \frac{ⅆ ( \sqrt{{g}^{2} + {x}^{2} ( t )} - g )}{ⅆ t} + BP ( t ) ; \frac{ⅆ x ( t )}{ⅆ t} = v ( t ) ;$$

$$where$$

$$α = arc tan \frac{x ( t )}{g} ;$$

$$\frac{ⅆ ( \sqrt{{g}^{2} + {x}^{2} ( t )} - g )}{ⅆ t} = \frac{x ( t )}{\sqrt{{g}^{2} + {x}^{2} ( t )}} \frac{ⅆ x ( t )}{ⅆ t}$$

The first equation describes forces acting on a mass M. The left side represents inertia, while the right side describes respectively: forces generated by springs, dashpots and the blood pressure input signal, where: x(t) is the wall displacement (output signal), g is the gap between rigid structure and sensing element, BP(t) blood pressure, v(t) velocity of wall displacement, η wall viscosity, and k is the wall elastic modulus. Choosing x(t) and v(t) as the state variables and labeling them x₁ and x₂ respectively, provides a simple linear system of differential equation describing nonlinear oscillator, as follows:

$$\frac{ⅆ {x}_{2}}{ⅆ t} = \frac{- 2 k}{M} ( \sqrt{{g}^{2} + {x}_{1}^{2}} - g ) sin ( arc tan \frac{{x}_{1}}{g} ) - \frac{2 η}{M} sin ( arc tan \frac{{x}_{1}}{g} ) \frac{{x}_{1}}{\sqrt{{g}^{2} + {x}_{1}^{2}}} {x}_{2} + \frac{BP ( t )}{M} ; \frac{ⅆ {x}_{1}}{ⅆ t} = {x}_{2}$$

A Runge-Kutta method, well known to those skilled in the art, may be employed to solve the system.

For some types of force transducers such as piezoresistive and piezoelectric, the transducer displacement x(t) may be reduced to micrometers or even angstroms (e.g. for piezoelectric transducers). Therefore, it may be desirable to neglect the contribution of wall longitudinal elasticity on the transducer response.

Considering a force that acts on a wall while the wall movement is restricted to very small displacements, provides:

$${lim}_{x \to 0 , v \to 0} F ( x , v ) = - 2 k sin ( α ) ( \sqrt{{g}^{2} + {x}^{2} ( t )} - g ) - 2 η sin ( α ) \frac{ⅆ ( \sqrt{{g}^{2} + {x}^{2} ( t )} - g )}{ⅆ t}$$

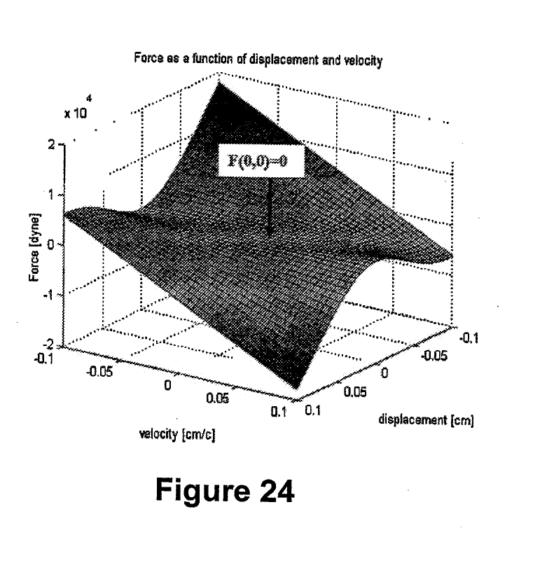

The limit may be equal to 0 and provide the F(x,v) 3D plot illustrated in FIG. 24, where the force acting on the arterial wall is shown as a function of function of displacement and velocity, x and v, respectively. Also, models may be employed that take into consideration linear and nonlinear forces acting on the transducer. This model may be used to simulate the system's dynamic behavior.

A complete lumped parameter model is described by a set of equations:

$$\frac{ⅆ {x}_{2}}{ⅆ t} = - {k}_{tr} {x}_{1} - {η}_{tr} {x}_{2} - \frac{2 k}{M} ( \sqrt{{g}^{2} + {x}_{1}^{2}} - g ) sin ( arc tan \frac{{x}_{1}}{g} ) - \frac{2 η}{M} sin ( arc tan \frac{{x}_{1}}{g} ) \frac{{x}_{1}}{\sqrt{{g}^{2} + {x}_{1}^{2}}} {x}_{2} + \frac{BP ( t )}{M} ; \frac{ⅆ {x}_{1}}{ⅆ t} = {x}_{2} ;$$

where x(t) is the wall displacement (output signal), g is the gap between rigid structure and sensing element, BP(t) blood pressure, v(t) velocity of wall displacement, η wall viscosity, k wall elastic modulus, ηₜᵣ transducer viscosity, kₜᵣ transducer elastic modulus, x₂transducer velocity, and x₁ is transducer displacement.

This model takes into consideration linear and nonlinear forces acting on the transducer. This model may be used to simulate the system's dynamic behavior. Several simulations may be performed to show: influence of the transducer stiffness Eₜᵣ on the transducer response and transducer response to the first 5 harmonics of the arterial blood pressure signal.

Simulation may be run for typical muscular artery parameters where k=1000000 dyne/cm2; η=1200000 dyne/cm². The input signal, the arterial blood pressure wave, may be simulated by the first 5 subsequent harmonics of the input signal (from 1st to 5th). The amplitudes of harmonics were typical for the BP waveform recorded 45 cm from the aortic arch (approximately the border between the elastic and the muscular arteries). The frequency of the first harmonic is 1 Hz. Applied harmonics had the following amplitudes:

| Harmonic Number | Modulus [mmHg] |
|---|---|
| 1st | 9 |
| 2^{nd} | 6 |
| 3^{rd} | 5 |
| 4^{th} | 1.8 |
| 5^{th} | 1.8 |

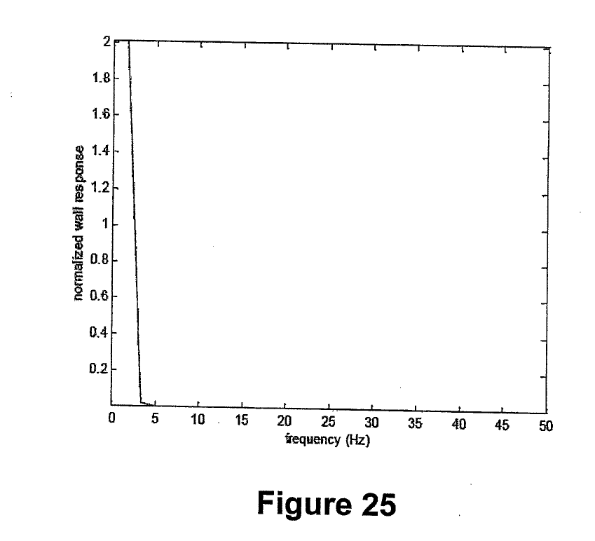

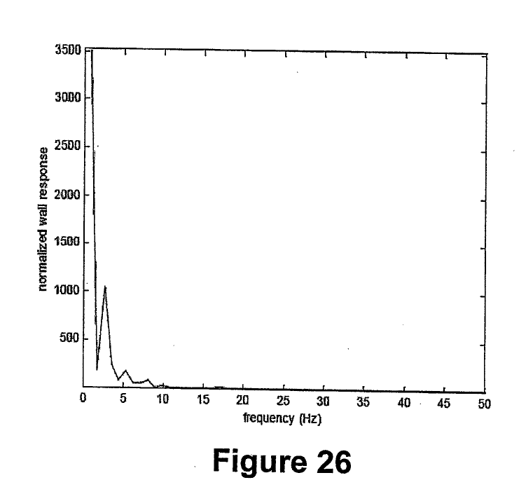

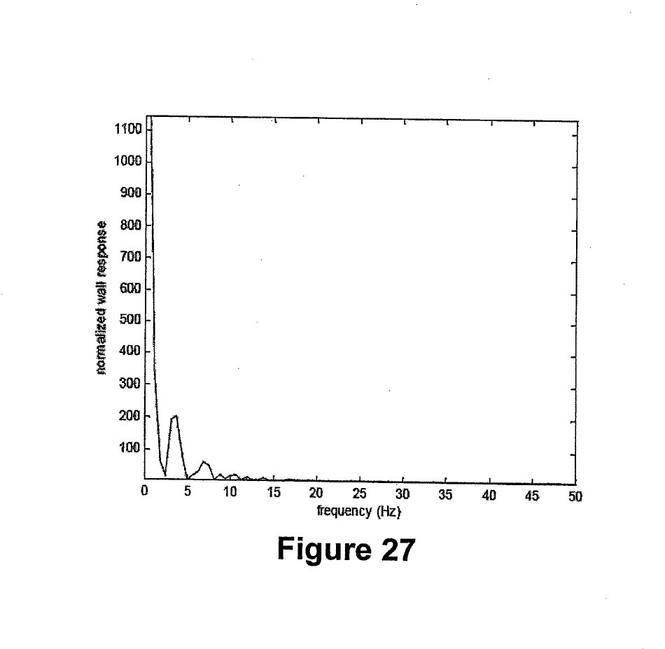

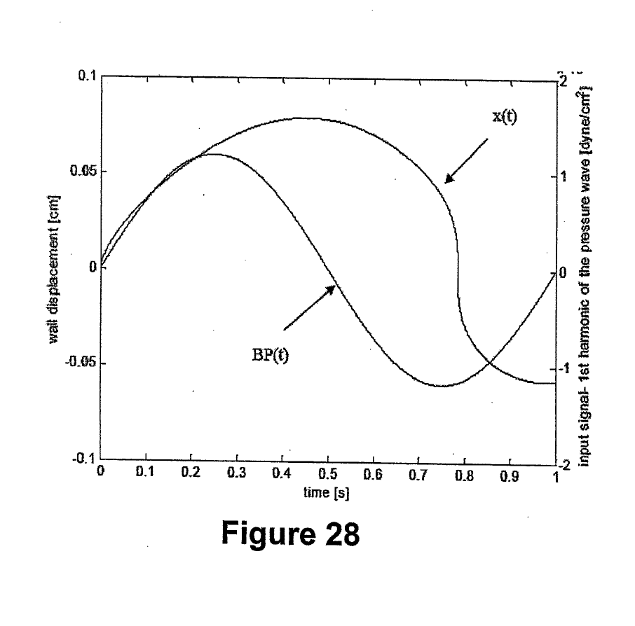

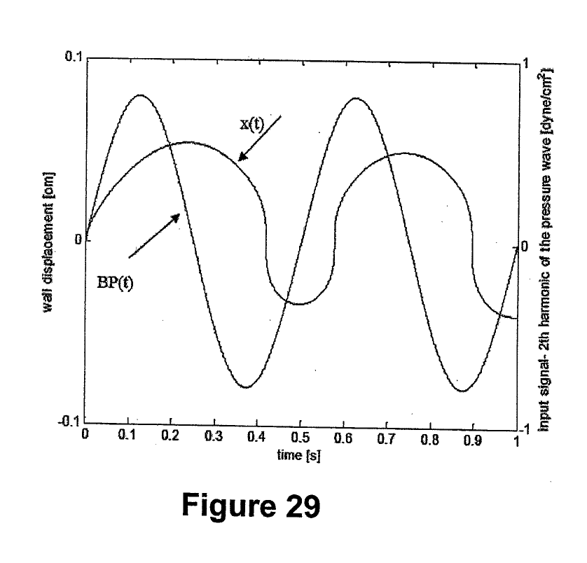

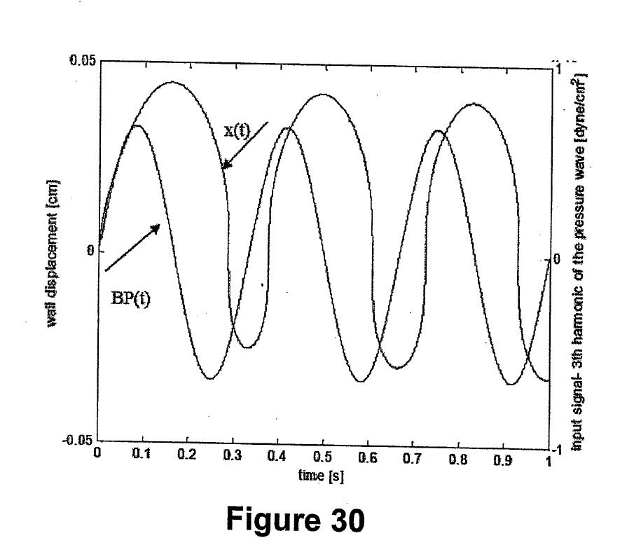

The frequency responses for the first three harmonics is shown in FIGS. 25-27, and the comparison in time domain between the input signal and the arterial wall response for the first three harmonics is shown in FIGS. 28-30.

The spectral content of the wall response may be independent from the wall elasticity. Additional harmonics may be generated in arterial wall response spectrum. The relationship between amplitudes of additional harmonics may be described by the equation:
AₙAe^{cnf}e^{anf-b}
where Aₙ is the amplitude of n-th harmonic, and A, a, b, c are constants, f is frequency of the input signal, and n is a harmonic number. The calculated constants may be A=414116; a=0.0734; b=0.6552; c=-1.277.

The transducer system may permit the use of different sensor head stiffness because the linearity of the system may change with sensor head stiffness. For example, a transducer stiffness higher than E=108 dyne/cm² may produces a linearity error less than 1% for input frequencies from 1-5 Hz.

The arterial wall may not be a homogenous or isotropic structure, or a Hookean material. As a result, strain measurement may be a complicated function of stress and its first derivative. In some embodiments, such as those with small strain and low frequency, some simplifications may be made. For example, if strain is small, the nonlinear behavior can be linearized. Also, if strain is small, the non-isotropic behavior may be neglected. This may simplify the stress-strain relationship to the Hookean case:
σᵢⱼ=cᵢⱼₖₗeₖₗ
where σᵢⱼ is stress tensor; cᵢⱼₖₗ tensor of elastic constants independent of stress or strain; eₖₗ strain tensor. Furthermore, the cᵢⱼₖₗ tensor consists of two independent variables. Usually the arterial wall mechanical properties are described by the Young's modulus E, and Poisson's ratio v.

The FE model may represent the object, i.e. arterial wall, under two types of loads: physiological arterial blood pressure pulsation BP(t) and applanation (flattening by the tonometer).

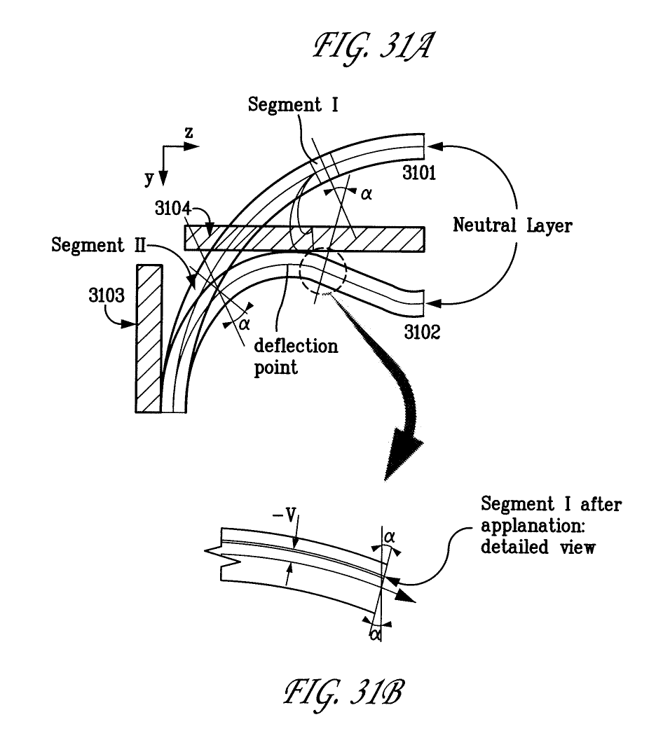

FIGS. 31A and 31B provide a general view of the artery deformed by applanation. As shown in FIG. 31A, 3101 is a non-deformed artery and 3102 is a deformed artery. The arterial wall under applanation, with no pressure applied, which is kept inside the support structure may be represented by two elements: 3103 and 3104, as shown in FIG. 31A. The 3103 element represents the portion of the U-shaped structure while the 3104 element represents the applanation flat area of the sensor. The free artery is labeled as 3101 while 3102 indicates the artery compressed by the element 3104 and restricted by the element 3103.

The whole artery undergoes a deformation, and each region of the free artery is deformed by the support structure. Transition from the free artery 3101 to the compressed artery 3102 for two segments of the artery. Each segment of the arterial wall may be bent by the moment of forces L and each cross-section may be rotated by angle α. This rotation generates elongation or shortening of layers equal δl above or beneath the neutral layer (the layer that does not undergo any strain). Thus the stress-strain relationship applied to the layer is given by the equation:

$${T}_{ZZ} = E \frac{Δ l}{l}$$

where E is Young's modulus and T_{zz} is stress along the z axis, Δl is elongation due to stress, l is length of the segment, provides:

$$Δ l = - ya$$

$$which provides \text{:}$$

$${T}_{ZZ} = E \frac{E α}{l} y$$

The contribution to the momentum L of the force acting on the infinitesimally thin layer is:
dL=−yT_{zz}bdy
Where dy is the layer thickness and b is an assumed wall dimension along the x axis. Thus, integrating from −h/2 to h/2, one obtains:

$$L = {\int }_{- h / 2}^{h / 2} {y}^{2} ⅆ y = \frac{{Edh}^{3}}{12 l} α$$

$$α = \frac{2 lL}{{bh}^{3} E}$$

The equation gives the relationship between the angle a and the bending momentum L. To obtain a displacement uₗ of the arterial segment along the y axis, one has to substitute:
Tₓₓ=T_{yx}=T_{zx}=0,
T_{xy}=T_{yy}=T_{zy}=0,
to the tensor stress-strain relationship:
Tₓₓ=λσ÷2 μsₓ
T_{xy}=2 μe_{xy}
T_{xz}=2 μe_{xz}
and knowing that E can be expressed using Lame coefficients:

$$E = \frac{μ ( 3 λ + 2 μ )}{λ + μ}$$

$$0 = λ \tilde{σ} + 2 μ {s}_{x}$$

$$0 = λ \tilde{σ} + 2 μ {s}_{x}$$

$${T}_{ZZ} = λ \tilde{σ} + 2 μ {s}_{x}$$

$${e}_{yz} = {e}_{zx} = {e}_{xy} = 0$$

By adding first three equations provides:

$$( 3 λ + 2 μ ) \tilde{σ} = \frac{E α}{l} y$$

By elimination of the Young's modulus and introducing Poisson's ratio provides:

$$\tilde{σ} = - \frac{μ}{λ + μ} \frac{α}{L} y = - \frac{2 η μ}{λ} \frac{α}{l} y$$

$$and$$

$${s}_{x} = {s}_{y} = - \frac{λ}{2 μ}$$

$$\tilde{σ} = η \frac{α}{l} y$$

$${s}_{z} = \frac{λ + μ}{μ} \tilde{σ} = - \frac{α}{l} y$$

considering the characteristic equation, a the system of partial differential equation can be written in the following form:

$$\frac{\partial {u}_{x}}{\partial x} = \frac{η α}{l} y , \frac{\partial {u}_{z}}{\partial y} + \frac{\partial {u}_{y}}{\partial z} = 0$$

$$\frac{\partial {u}_{y}}{\partial y} = \frac{η α}{l} y , \frac{\partial {u}_{x}}{\partial z} + \frac{\partial {u}_{z}}{\partial x} = 0$$

$$\frac{\partial {u}_{z}}{\partial z} = \frac{α}{l} y , \frac{\partial {u}_{y}}{\partial x} + \frac{\partial {u}_{x}}{\partial y} = 0$$

Where: uₓ displacement along x, u_{y} displacement along y_{,}u_{z} displacement along z, η Poisson's ratio.

The solution of these equations generates the geometry of the arterial wall after applanation. Since the internal arterial wall will be loaded with hydrostatic pressure BP=−T thus:
Tₓ₍ₙ₎=Tcos(n,x);T_{y(n)}=Tcos(n,y);T_{z(n)}cos(n,z)

Despite the fact that the applanation may be applied by constant force, the contact pressure response in some places of the flattened area (e.g. center) is nonlinear and even non-monotonic. As a result, the contact pressure may not rise with the applanation force in monotonic fashion.

Also, some aspects of the system may change with blood pressure applied to the artery. The pressurized artery may start to adhere to the tonometer surface and the contact pressure may become a sum of blood pressure and stresses related to applanation. The residual stress generated by applanation may be responsible for discrepancies between blood pressure and contact pressure. It is especially apparent close to the transducer edge and far from the vessel axis. Distribution of the contact pressure between the tonometer head and the arterial wall is not homogenous.

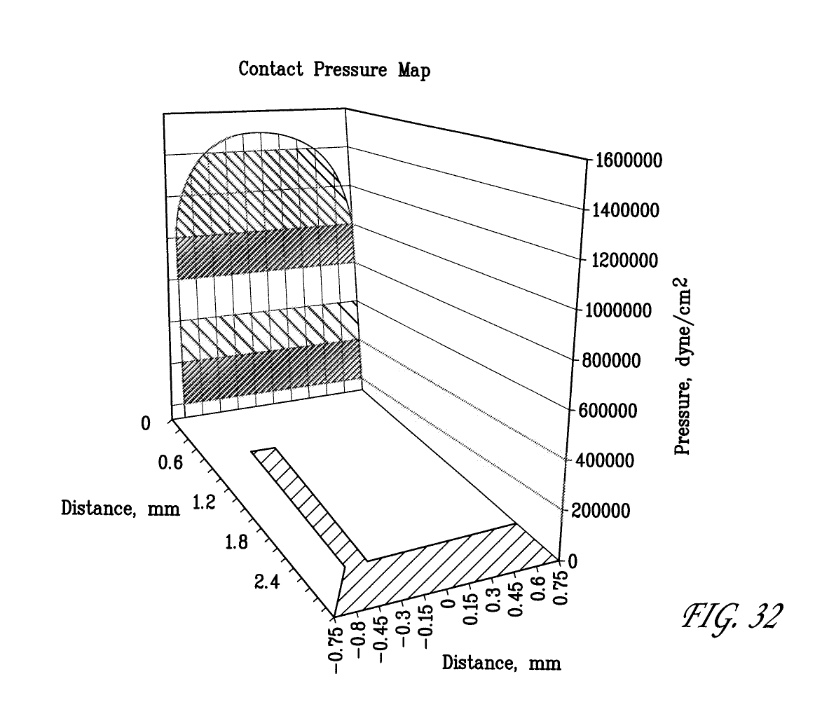

FIG. 32 provides one example map of contact pressure in systole where E_{wall}=600,000 dyne/cm². The maximum of the contact pressure gradient may be located under the transducer's edge, then sharply drop, undergo some minor fluctuations and stabiliz approximately 2 mm from the sensor edge. Also, in the direction perpendicular to the vessel axis, the contact pressure gradient may reach its maximum on the edges of the applanation region.

The criterion of 1% error may be met (for arterial stiffness from E_{wall}=500,000 to 1,000,000 dyne/cm² and applanation level from ˜8% to ˜22%) in the region starting 2 mm from the senor head edge, measured along the vessel axis and 0.3 from the vessel axis, measured transversally to the axis. Thus, the sensing area may not be closer to the tonometer's front edge than 2 mm and not further from the vessel axis than 0.3 mm. These restrictions may guarantee that the contact pressure on the transducer will not change under physiological conditions, due to the applanation level or arterial stiffness, more than 1% of its value.

This may contradict the traditional tonometry assumption that applanation generates some area on the flattened artery, where the contact pressure is constant and proportional to the blood pressure signal. In general, as shown in FIG. 32, the closer to the arterial wall plane of symmetry, the lower the amplitude of the contact pressure. Also, the contour of the contact pressure may not reflect exactly the contour of the measured blood pressure. In some areas, especially on the margins of the sensing head, the contact pressure may sharply rise during the systole but drops to zero (i.e., loss of the mechanical contact between the arterial wall and the tonometer) at the end of the diastolic period. This illustrates the fact that the arterial wall may not be fixed to the tonometer and the margins of the applanation area may be moving by responding to the arterial pressure changes. This movement may result in rapid changes of the contact pressure and even in loss of contact between the arterial wall and the sensor.

The contact pressure and the arterial blood signal typically do not share the same contour (signal spectrum) even if measured in an optimal location. The contact pressure measured in the center of the applanation area may not be in exact agreement with the contact pressure response. Although the amplitude of the blood pressure signal may be the same, the contact pressure signal may underestimate the pressure signal almost over the whole cardiac cycle.

Also, the tonometer may apply unnatural strain inside the arterial wall. The flattened area may undergo the biggest negative strain (compared to the relaxed non-pressurized artery). On the other hand, the corners may undergo the highest strain. This may suggest that the flattened portion and the corners will undergo some kind of physiological reaction as a response to unnatural strain.

Typically, the transducer for a tonometer working on a living artery should exhibit low mechanical compliance (E_{Tr}≧.10⁸ dyne/cm²). This requirement as well as a desire to obtain an easy to analyze, high amplitude, high power signal has resulted in the PZT based transducer, designed to fit the tonometer prototypes.

In some embodiments it may be desirable to minimize the tonometer error due to the contact pressure gradient, and to design a device capable of obtaining an experimental relationship between the applanation level and the tonometer output amplitude and accuracy.

In some embodiments, it may be desirable for the tonometer not to deform the artery or the deformation should be minimal in order to preserve the natural blood flow conditions and the natural stress distribution within the arterial wall tissue. From the sensor point of view, the level of deformation may be optimal for the measurement, which means a relatively large area of flat arterial wall (e.g., between 8% and 22% of applanation). These two requirements may be contradictory, because the applanation suitable for blood pressure measurement may require theoretically at least 8% artery compression. The transducer provides a conversion from mechanical stress to the electrical output signal. The transducer type selection process and the transducer design are presented prior to the specific tonometer designs.

There are several sensing mechanisms that have been historically used for the development of the force/stress transducers. Currently, most force transducers are based on piezoelectric, piezoresistive, optical, and capacitive sensing techniques. These techniques, except perhaps piezoelectric, require a relatively large mechanical deformation of a sensing element in order to achieve high sensitivity and large dynamic range of the measured force. Therefore, a typical design approach may utilize a relativey thin membrane (high “effective” mechanical compliance) as an interface, which transforms the force into the large deformation, and which may be detected by a displacement transducer. As a result, these techniques may suffer in the case of the applanation method, where a rigid transducer is required at the contact area between the artery and the tonometer.

In the embodiment that use a piezoelectric force transducer, for example, transduction of mechanical quantities (force, displacement) into electrical (voltage, charge or current) and vice-versa takes may place within the material via the deformation of the crystal lattice. This sensing mechanism may allow the transducer to detect the deformation in the order of angstroms, and allow measuring the force with virtually no displacement (which potentially reduces nonlinearity of the tonometer).

The PZT transducer may not need a macroscopic deformation (such as bending) in order to measure the force applied to the rigid applanation element. Also, the material-based electromechanical coupling effect may lead to two distinct modes of operation of the transducer. A passive mode may refer to a direct generation of an output voltage or electric charge under the acting force. In this case the sensor may not need an external power supply to produce a response, which may be advisable for implantable sensors.

The relation between acting forces (stresses) and responses (the output voltage or charge) can be derived from the constitutive relations for piezoelectric materials. In most cases, the modeling and analysis may be carried on for finite size devices, therefore the considered variables are presented in the form of stresses (force over the area), electric fields (voltage over the thickness), and electric induction (charge over the area):
Tᵢⱼ=cᵢⱼₖₗSₖₗ−eₙᵢⱼEₙ
Dₘ=eₘₖₗSₖₗ+εₘₙEₙ
where: T is stress, D is an electric charge, S is deformation, E is electric field, c is elastic constant, e is piezoelectric coefficient, and ε is dielectric constant.

From these equations one typically may determine the magnitude of the electric charge (D vector), or the voltage (from E vector) caused by the applied force. These equations are linear, which may implicates that, in principle, both static and dynamic forces can be measured. An approach here may be to make the sensing element a finite size with system electrodes placed on its surfaces. Such an element, from an electrical point of view, may be a capacitor, and this element under the acting static force may discharge or leak the electric charge. Therefore, this mode of operation may not be used for static pressure measurements. However, it may exhibit excellent sensitivity, linearity and wide band frequency response (from 0.0 1 Hz to several MHz) in measurement of dynamic pressures.

The table below illustrates a piezoelectric force sensor operating range associated with passive and active sensing. As shown, the amplitude sensitivities of the piezoelectric sensing plates of the shape of a thin disk are included. The table shows the strong voltage response of the order of mV for the physiological pressure range.

| | | | Frequency |
|---|---|---|---|
| | | Voltage (V) at | Shift (Hz) at |
| Sensor | Deformation (m) at | 80 mmHg-120 | 80 mmHg-120 |
| Material | 80 mmHg-120 mmHg | mm Hg | mmHg |
| SiO2 | 1.27 × 10⁻¹¹-2.04 × 10⁻¹¹ | 5.8 × 10⁻⁴-9.1 × | 90-145 |
| (x-cut) | | 10⁻⁴ | |
| LiNbO3 | 5.02 × 10⁻¹¹-8.03 × 10⁻¹¹ | 2.3 × | ˜30 |
| (z-cut) | | 10−2-3.78 × 10⁻² | |
| PZT | 1.55 × 10⁻¹¹-2.48 × 10⁻¹¹ | 0.261-0.416 | ˜20 |

The force sensitivities evidence attractiveness of piezoelectric materials for tonometer applications. Also, the deformation of the piezoelectric element may be negligible, and the amplitude of the voltage and the change in the frequency are large and easy to measure. The second mode referred as an active mode of operation may utilize nonlinear features of piezoelectric materials under an applied force. The features state that under the force, the material parameters of piezoelectric materials (such as elastic, dielectric and other constants) may undergo changes that are linearly proportional to the applied force. The nonlinear constitutive equations can be written in the following form:

$${T}_{ij} = ⌊ {c}_{ijkl} + \frac{1}{2} {c}_{ijklqr}^{*} {S}_{qr}^{*} ⌋ {S}_{kl} - ⌊ {e}_{nij} + \frac{1}{2} {e}_{nijqr}^{*} {S}_{qr}^{*} ⌋ {E}_{n}$$

$${D}_{m} = ⌊ {e}_{mkl} + \frac{1}{2} {e}_{mklqr}^{*} {S}_{qr}^{*} ⌋ {S}_{kl} + ⌊ {ɛ}_{mn} + \frac{1}{2} {f}_{mnqr}^{*} {S}_{qr}^{*} ⌋ {E}_{n}$$

where the parameters with “*” represent the nonlinear materials constants coupled with the acting force, and S* represents the deformation of the crystal caused by the acting force. The appropriate measuring devices, which accurately and conveniently measure the induced changes in the material due to the acting force, can be engineered in the form of a resonant piezoelectric system or phase detector. Typically, the change in the device resonant frequency Δf_{R} is measured:
Δf_{R}=F×(Kf_{R}n)/w
where F is acting force; K is nonlinear material constant; f_{R} is resonant frequency of the sensor; w is frequency, n is order of the harmonic mode of the sensor and w is size of the sensor.

Although in some embodiments in order to simplify the measurement system design, to utilize the phase shift detector, where the phase shift is given by the formula:
ΔΦ=F×C
where ΔΦ is a phase shift between the input voltage excitation and output voltage measured on the input and output ports of the transducer, F is applied stress and C is a constant specific to the sensor geometry and piezoelectric properties of the transducer.

A PZT-5 transducer may be used to convert stress generated by blood pressure to voltage. This permits a high output voltage in a passive mode of operation and a relatively high power of the output signal.

At least two different phenomena may be utilized as a sensing mechanism. The spectrum of the pressure waveform may be reconstructed using a simple piezoelectric effect. Voltage generated on transducer electrodes may be collected by conditioning charge amplifier and sent to a digital oscilloscope and a data acquisition system. The voltage may be proportional to the first time derivative of pressure:

$${V}_{out} = K \frac{ⅆ P ( t )}{ⅆ t}$$

Actual pressure P(t) may be measured using various mechanisms. Due to nonlinear properties of the piezoelectric material, stress applied to the PZT structure may change velocity of the electro-acoustic wave propagated in the material. This velocity change may be used to measure applied stress. Not all frequencies may be affected in the same way. For example, some frequencies, depending upon sensor geometry and material properties, may affected more, some less (e.g., 260-320 kHz). Absolute pressure value P(t) may be measured using a phase shift between the applied sinusoidal signal and the signal passing through the transducer.

These two example modes of operation may be combined to measure a complete blood pressure waveform (i.e., direct piezoelectric effect to reconstruct shape and peak-to-peak amplitude, and phase shift to calibrate the device to absolute pressure measured within the artery).

The artery and the PZT transducer may be coupled by a rigid plastic pin. The pin may be leveled with a rigid surface of the housing. Due to its shape, the pin may act as a force divider distributing the mechanical stress collected by the narrow end and passing it to the transducer surface. The pin may be separated from the housing by an air gap and may form a mechanical bridge between an arterial wall and the transducer.

A hand-held tonometer also is contemplated in the embodiments. This device may be able to operate both in a laboratory setup and a living organism. An arterial tonometer may be constructed for the short-term arterial pressure waveform measurements, performed on an exposed artery of the anesthetized animal, without implanting the tonometer into the subject body. An arterial tip may be designed to stay in the animal organism for a short period of time, while the mechanical applanation mechanics may stay outside the body.

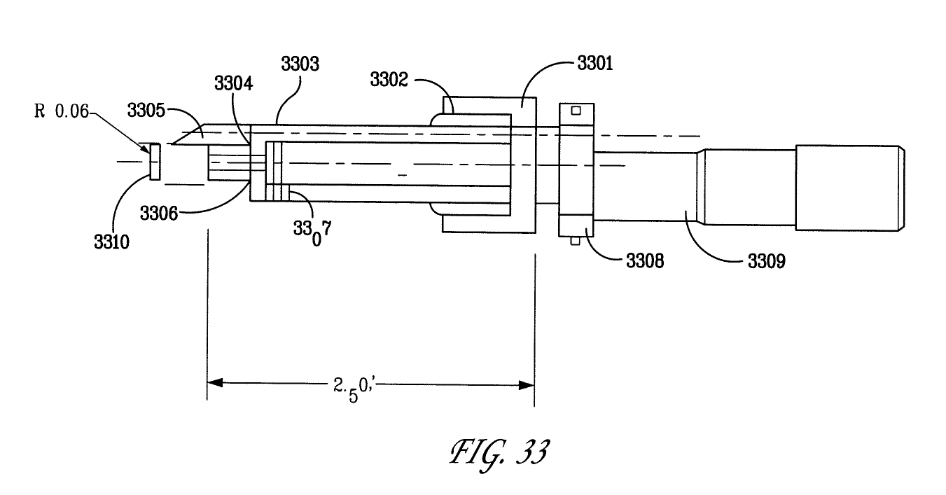

FIG. 33 illustrates an example of a hand-held tonometer. As shown in FIG. 33, a hand-held tonometer may be in the form of a pen-like shape with the transducer mounted on the tip of the device. The contact pressure may be collected by a pin 3306. The desired level of applanation can be achieved by a micrometer screw 3309 driving the applanation mechanism 3310.

The micrometer screw may be move the U-shaped support structure 3305 in relation to the rigid support structure (transducer housing 3303). The U-shaped support structure may be equipped with inserts 3305 that hold the artery. The inserts may be fabricated with diameters ranging from 2.0 mm to 4.0 mm (0.25 mm increments) to accommodate a wide range of arterial diameters.

This type of design may allow for the device to be used with the different arterial diameters. A surgeon may measure the diameter of the artery with a caliper, and the appropriate insert can be chosen to optimize mechanical fixation and minimize vessel lumen compression.

The hand-held prototype coupling mechanism may be designed to meet hermetic sealing requirements regarding protection of the PZT transducer against moisture. A thin aluminum foil may be glued (e.g., using epoxy adhesive) over the surface of the rigid-planar body to provide a hermetic seal. The foil may be glued only to the housing of the transducer, leaving the connection between the pin and the foil relatively free. This technique may minimize transmission of shear forces to the transducer. Covering the transducer pin with foil (e.g., 25 micrometer thickness) may be sufficient to provide hermetic sealing. As a result, the tip of the hand-held device may be able to operate in contact with moisture and liquid.

The implantable devices working in living environment may require stable support for the vessel. One way this may be accomplished is by stabilizing the artery during the measurement process and by providing a constant level of applanation. The traditional external tonometry uses the subject's bones as a platform on which the applanation process can be performed, but if the device is intended for implantation this concept may not be practical in some embodiments.

The artery may be encircled by the tonometer and may be pushed against the force transducer by a hook-like support structure to provide a stable position on the artery with respect to the transducer sensing area (e.g., rigid pin) by holding the artery between the hook-like support structure and the rigid body with the incorporated piezoelectric senor. The hook-like structure may enable a surgeon to insert the artery into the tonometer measurement area and then compress it by tiding the micrometer screw that elevates the hook-like support structure.

The U-shaped supporting structure may be designed to change its distance from the tonometer's body, providing a wide range of applanation levels. The PZT transducer may be placed inside the tonometer's cigar-shaped body, for example. The blood or liquid pressure signal may be collected by a pinthat transferred pressure to the PZT transducer.

The spectrum of the pressure waveform may be reconstructed using a direct piezoelectric effect. Voltage generated on the transducer's electrodes may be collected by a conditioning charge amplifier and sent to the digital oscilloscope and data acquisition system (i.e., the voltage is proportional to the first time derivative of pressure).

The actual pressure P(t) may be measured using the active mode. Due to nonlinear properties of the piezoelectric material, stress applied to the PZT transducer may change velocity of the electro-acoustic wave propagated in it.

To measure applied stress, the phase shift between the signal entering the transducer and coming out of it may be measured. For example, the frequencies may be chosen with maximum phase shift (i.e., the frequencies for which the phase shift change per 1 Pascal of applied pressure may be a maximum). The absolute pressure value P(t) may be measured using the phase shift between the applied sinusoidal signal (1 Vₚ₋ₚ amplitude) and the signal passing through the transducer.

Multiple modes of operation may be combined to measure complete blood pressure waveform, for example, direct piezoelectric effect to reconstruct shape and peak-to-peak amplitude, and phase shift to calibrate the device to absolute pressure measured within the artery.

The signal conditioning system may be equipped with additional filtering options (e.g., HP infinium signal averaging option (averaging for 4 samples) and a sine filter).

The fabrication technology utilized in the hand-held prototype may enable using the device in contact with living tissue without causing trauma. Thus, the body of the tonometer may be fabricated out of stainless steel, edges may be smoothly rounded to avoid injury of the arterial wall and minimize the arterial spasm caused by the contact with sharp edges. The aluminum foil may be glued using medical grade epoxy adhesive to provide the hermetic sealing of the transducer tip. The cables may be shielded with the aluminum foil, and the whole device may be covered by the latex protection layer.

The transducer may be placed inside the transducer body by using a fit-press technique. The PZT cylinder may be separated from the stainless steel housing by the plastic band.

The tonometer pin may be glued to the PZT transducer with the epoxy adhesive.

In addition to using PZT transducers, a single piece of metal to fabricate the housing and the membrane may be used. This may permit not having to seal between the membrane and the housing. The device may be designed to perform long-term experiments in a living organism.

The tonometer also may be capable of performing BP real-time measurements on the aorta of smaller subjects (e.g., a 20-30 kilogram dog or mini pig that have less motion artifacts). The choice of the target artery may determine the tonometer size and shape. It may be designed to be mounted on the artery by adding a tongue-and-groove mechanism connecting the U-shaped support structure to the tonometer senor head.

In addition, the implantable tonometer device that stays around the artery may have a shape sufficiently compact to avoid excessive compression of surrounding tissue. Also, its shape may minimize bending and twisting of the artery to avoid artery compression leading to blood flow decrease. The wires may be mechanically secure to avoid motion artifacts, and it may be desirable to place some length of the wire along the artery. The wire stress may be mechanically unloaded by leaving some extra length forming a loop close to the tonometer. For example, a miniature, stainless steel arterial tonometer may be desirable.

The coupling mechanism in this prototype may be a thin stainless steel membrane and a rigid plastic pin. The membrane may be an integral part of the housing. The relatively small deflection of the transducer may not require good flexibility of the contact pressure transmitting membrane. The transducer may be coupled to the artery in a variety of ways. The PZT cylinder may be sandwiched between the rubber layer and the rigid pin. The sides of the transducers may be free and separated from the housing by an air gap. The membrane may be supported by a washer that allows the membrane to deflect only on the small area of 2 mm in diameter and separate the transducer from the peripheral high contact pressure gradients.

The applanation mechanism may be simplified in order to meet the implantation requirements. For example, the applanation level and the support for the artery may be provided by the geometry of the removable U-shaped support structure. The support structure may be attached to the tonometer housing by the tongue-and-groove mechanism, for example. This solution may make it easy to mount the tonometer around the artery and, at the same time, secure a very stable measurement platform after the support structure is fixed.

The measurement system of the implantable prototype may be analogous to the system used with the hand-held prototype. The implantable device may be connected to the measurement devices via a jack. The jack may be mounted on the shield and covered with silicon cable. The cable after the measurements is disconnected from the measurement system, may be covered with the additional silicone protection and buried under the subject's skin. It may stay in the subject's body until a next experiment. This kind of connection may decrease the SNR ratio, especially in a passive mode.

The 8.0 mm×12.0 mm×8.0 mm sensor head, for example, may be machined from implant grade stainless steel and finished to a smooth-round contour. Packaging methods may be developed to provide a long-term hermetic seal without adversely affecting the transducer's ability to measure the underlying vessel wall forces. Also, a one-piece metal housing may be designed with a machined channel for the PZT transducer and pin. In some embodiments, a 25-micrometer wall of stainless steel may separate the transducer pin from the underlying blood vessel wall.

The miniature sensor head may be machined with gentle curves to avoid tissue trauma and geometry to maintain optimal alignment of the transducer pin with the flattened portion of the arterial wall. An O-ring, compression fitting and coatings of implant grade silicone may be added to the top of the sensor head to minimize the risk of invading moisture. Transducer wires may be placed within a thin, flexible elastic catheter (e.g., a Hickman Catheter), the lumen of which may subsequently be filled with implant-grade silicone. The catheter and strain relief assembly may be attached to the rigid-planar body (e.g., transducer platform) with a clip and silicone adhesive. U-shaped support structures may be machined from implant-grade stainless steel (e.g., 5.0 mm to 7.0 mm inner diameter−0.25 mm increments for mini pig abdominal aorta) and finished to a smooth-round contour. The upper arms of the U-shaped structure may attach firmly to the rigid-planar body using a tongue-and-groove design.

What is claimed is:

1. A method for measuring a fluid characteristic in a conduit, the method comprising:
applying a planar force to the conduit;
receiving a pressure from the conduit, wherein the pressure is responsive to the fluid and the conduit, and wherein the pressure is received within a predetermined area; and
processing the pressure to determine the fluid characteristic.

2. The method of claim 1, wherein the planar force is applied to an area at least equal to an outer radius of the conduit.

3. The method of claim 1, wherein the conduit is flexible.

4. The method of claim 1, wherein the conduit carries blood.

5. The method of claim 2, wherein the conduit is at least one of the following: artery, vein, gastrointestinal tract, lymphatic vessel, urinary track, air track, and trachea.

6. The method of claim 1, wherein the conduit is a pipe.

7. The method of claim 1, wherein the planar force causes the conduit to become substantially planar.

8. The method of claim 1, wherein the pressure is varying.

9. The method of claim 1, wherein the fluid characteristic comprises at least one of the following: systolic pressure, diastolic pressure, mean pressure, and pressure waveform.

10. The method of claim 1, wherein the pressure is transmitted and received by at least one of the following transducers: piezoelectric, piezoresistive, capacitive, magnetostrictive, optical, and inductive.

11. The method of claim 1, wherein the fluid characteristic is transmitted wirelessly.

12. The method of claim 1, wherein the conduit is substantially rigid.

13. A device for measuring a fluid characteristic in a conduit, the system comprising:
a support structure for supporting the conduit;
a sensor head in cooperation with the support structure, wherein the sensor head applies a planar force to the conduit, and wherein the sensor head has a portion least equal to an outer radius of the conduit; and
a pressure transducer located on the sensor head, wherein the pressure transducer receives a pressure from the conduit that is responsive to the fluid and the conduit, and wherein the pressure transducer is located within a predetermined area on the sensor head.

14. The device of claim 13, further comprising a processor for processing the pressure to determine a fluid characteristic.

15. The device of claim 14, further comprising a transmitter in communication with the processor, wherein the transmitter communicates information related to the fluid characteristic.

16. The device of claim 15, wherein the information is a warning signal communicated to a medical professional for medical intervention.

17. The device of claim 15, wherein the information is communicated over the Internet to a health system.

18. The device of claim 13, wherein the support structure comprises a rigid housing with a flat bottom portion and rounded edges.

19. The device of claim 18, wherein the flat bottom portion comprises an elongated area positioned in the center sensor head, and wherein the pressure transducer is located on the elongated area.

20. The device of claim 13, wherein the device is implantable.

21. The device of claim 13, further comprising a controller in communication with the pressure transducer, wherein the controller provides automated drug delivery.

22. The device of claim 13, wherein the pressure transducer comprises an array of piezoelectric sensors.

23. The device of claim 13, wherein the device is a cardiac bypass.

24. The device of claim 23, wherein the cardiac bypass correlates a response of the pressure transducer with a condition of a cardiac system.

25. The device of claim 24, wherein the condition of the cardiac system includes at least one of the following: flow obstruction, plaque accumulation, incoming heart attack, and drug management.

26. The device of claim 13, further comprising an electronic device in communication with the pressure transducer, wherein the electronic device excites the pressure transducer into a predetermined vibration mode.

27. The device of claim 26, wherein the electronic device measures a change in an operational parameter of the pressure transducer, and wherein the electronic device correlates the change with a characteristic of the fluid.

28. The device of claim 27, wherein the change in the operation parameter of the pressure transducer comprises at least one of the following: amplitude, frequency and phase.

29. The device of claim 13, wherein the pressure transducer provides a force to the conduit.

30. The device of claim 13, wherein the conduit is embedded in an enclosing structure comprising at least one of the following: tissue, protective multilayer industrial conduit, and functional multilayer industrial conduit.

31. The device of claim 13, wherein a characteristic of the pressure transducer is based on at least one of the following: dynamic range, signal-to-noise ratio, and fluid pressure.
